(19) United States
(12) Patent Application Publication
(10) Pub. No.: US 2013/0325887 A1
(43) Pub. Date: Dec. 5, 2013

(54) INFORMATION PROCESSING APPARATUS, INFORMATION PROCESSING METHOD, AND PROGRAM

(71) Applicant: SONY CORPORATION, Tokyo (JP)

(72) Inventor: Tomohisa TAKAOKA, Kanagawa (JP)

(73) Assignee: SONY CORPORATION, Tokyo (JP)

(21) Appl. No.: 13/865,433

(22) Filed: Apr. 18, 2013

(30) Foreign Application Priority Data
Jun. 1, 2012 (JP) 2012125940

(51) Int. Cl. G06F 17/30

(52) U.S. Cl. CPC G06F 17/30283
USPC 707/758

(57) ABSTRACT

There is provided an information processing apparatus including a first acquirer that acquires first behavior information, the first behavior information being detected by analysis of an image related to an object and indicating behavior of the object, a second acquirer that acquires second behavior information, the second behavior information being detected from an output of a sensor in a terminal device carried by or attached to the object and indicating the behavior of the object, and a matching unit that specifies a relationship between the object and the terminal device by matching the first behavior information to the second behavior information.

### BACKGROUND

The present disclosure relates to an information processing apparatus, an information processing method, and a program.

Cameras are now ubiquitous. For example, many surveillance cameras used for purposes such as security are installed at locations where people gather, such as transportation facilities and shopping centers. Additionally, it is becoming typically common for cameras to be built into terminal devices such as mobile phones. For this reason, there has been a tremendous increase in the number of situations where an image may be taken by a camera.

In these circumstances, technology that utilizes images taken by cameras is also progressing. For example, JP 2012-083938A describes technology related to a learning method for identifying faces appearing in an image. In this way, many technologies that automatically identify subjects in an image and utilize the identification results are being proposed.

### SUMMARY

Identifying a subject in an image by image analysis as with the technology described in the above JP 2012-083938A includes a procedure such as registering a sample image of the subject in advance, or ascertaining features of an image of the subject by learning. In other words, in order to identify a user appearing in an image, for example, data regarding an image in which the user appears has to be provided in advance.

However, an image of a user's face is the ultimate in personal information, and many users feel resistant to registering such data. Moreover, a user may not necessarily appear with his or her face towards the camera in an image that has been taken, and in such cases, user identification using an image of the face is difficult.

Thus, the present disclosure proposes a new and improved information processing apparatus, information processing method, and program capable of obtaining information that identifies a user appearing in an image, without registering information such as an image of the user in advance.

According to an embodiment of the present disclosure, there is provided an information processing apparatus including a first acquirer that acquires first behavior information, the first behavior information being detected by analysis of an image related to an object and indicating behavior of the object, a second acquirer that acquires second behavior information, the second behavior information being detected from an output of a sensor in a terminal device carried by or attached to the object and indicating the behavior of the object, and a matching unit that specifies a relationship between the object and the terminal device by matching the first behavior information to the second behavior information.

Further, according to an embodiment of the present disclosure, there is provided an information processing method including acquiring first behavior information, the first behavior information being detected by analysis of an image related to an object and indicating behavior of the object, acquiring second behavior information, the second behavior information being detected from an output of a sensor in a terminal device carried by or attached to the object and indicating the behavior of the object, and specifying a relationship between the object and the terminal device by matching the first behavior information to the second behavior information.

Further, according to an embodiment of the present disclosure, there is provided a program for causing a computer to realize a function of acquiring first behavior information, the first behavior information being detected by analysis of an image related to an object and indicating behavior of the object, a function of acquiring second behavior information, the second behavior information being detected from an output of a sensor in a terminal device carried by or attached to the object and indicating the behavior of the object, and a function of specifying a relationship between the object and the terminal device by matching the first behavior information to the second behavior information.

In an embodiment of the present disclosure, motion information is used to specify an object related to an image. Detecting first motion information from an image does not particularly request the registration of images of individual objects. Rather, the specification of an object is realized by matching the first motion information with second motion information acquired by a sensor in a terminal device carried by or attached to the object. Although the above involves information that at least temporarily associates a terminal device with an object, a user appearing in an image is identifiable without registering any other information in advance.

According to an embodiment of the present disclosure as described above, information identifying a user appearing in an image can be obtained without registering information such as an image of the user in advance.

### BRIEF DESCRIPTION OF THE DRAWINGS

FIG. 1 is a figure that diagrammatically illustrates a motion information matching process according to a first embodiment of the present disclosure;

FIG. 2 is a figure illustrating motion information acquisition using acceleration according to a first embodiment of the present disclosure;

FIG. 3 is a figure illustrating an example of acceleration information which may be used according to a first embodiment of the present disclosure;

FIG. 4 is a figure illustrating an example of acceleration information which may be used according to a first embodiment of the present disclosure;

FIG. 5 is a figure illustrating a diagrammatic system configuration for providing an ad delivery service according to a first embodiment of the present disclosure;

FIG. 6 is a figure illustrating a modification of a diagrammatic system configuration for providing an ad delivery service according to a first embodiment of the present disclosure;

FIG. 7 is a block diagram illustrating a schematic functional configuration of a terminal device according to a first embodiment of the present disclosure;

FIG. 8 is a block diagram illustrating a schematic functional configuration of a matching server according to a first embodiment of the present disclosure;

FIG. 9 is a block diagram illustrating a schematic functional configuration of a monitor server according to a first embodiment of the present disclosure;

FIG. 10 is a block diagram illustrating a schematic functional configuration of an ad delivery server according to a first embodiment of the present disclosure;

FIG. 11 is a figure illustrating a diagrammatic system configuration for providing a positioning service according to a second embodiment of the present disclosure;

FIG. 12 is a block diagram illustrating a schematic functional configuration of a position delivery server according to a second embodiment of the present disclosure;

FIG. 13 is a figure illustrating a diagrammatic system configuration according to a third embodiment of the present disclosure;

FIG. 14 is a figure that diagrammatically illustrates a fourth embodiment of the present disclosure;

FIG. 15 is a figure illustrating a diagrammatic system configuration according to a fifth embodiment of the present disclosure;

FIG. 16 is a figure illustrating a modification of a diagrammatic system configuration according to a fifth embodiment of the present disclosure; and

FIG. 17 is a block diagram for describing a hardware configuration of an information processing apparatus.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, the description will proceed in the following order.

1. First embodiment
1-1. Process overview
1-2. Acquisition of motion information from sensor
1-3. Specific example of matching
1-4. System configuration for providing service
1-5. Functional configuration of each device

2. Second embodiment
2-1. System configuration for providing service
2-2. Functional configuration of devices
2-3. Additional uses for image processing

3. Third embodiment

4. Fourth embodiment

5. Fifth embodiment

6. Hardware configuration

7. Supplemental remarks

### 1. First Embodiment

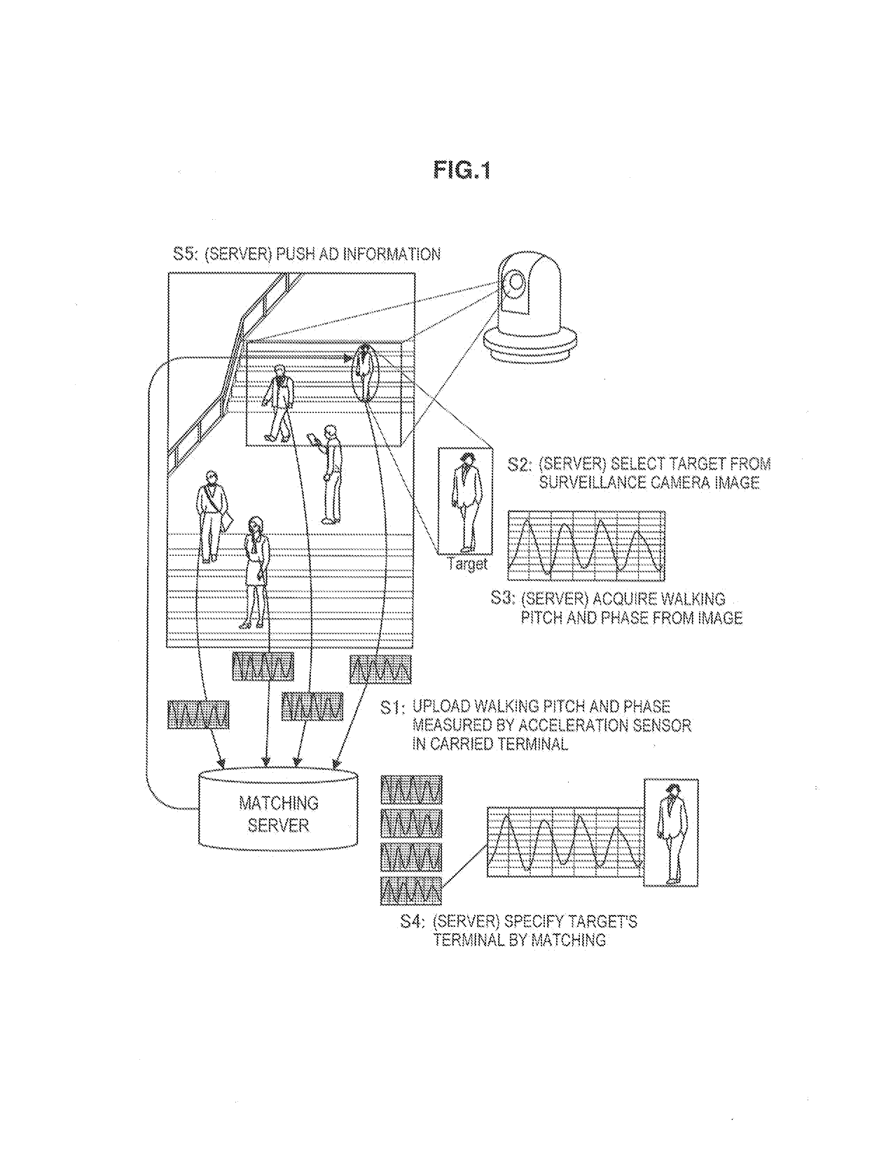

First, the first embodiment of the present disclosure will be described with reference to FIGS. 1 to 4. The present embodiment specifies a terminal device carried by a target user specified in an image from a surveillance camera or other camera installed in a location such as a shopping mall, for example, and pushes ad information to that terminal device. Thus, it is possible to provide ad information via a terminal device to a desired ad information recipient who is recognized from an mage.

(1-1. Process Overview)

FIG. 1 is a figure that diagrammatically illustrates a motion information matching process according to the first embodiment of the present disclosure. As illustrated in FIG. 1, in the matching process according to the present embodiment, the walking pitch and phase measured by an acceleration sensor in a terminal device carried by individual users are uploaded to a matching server as one set of inputs (S1). Additionally, a target user is selected in a surveillance camera image in which multiple users appear (S2), and the walking pitch and phase of the target user are acquired by image analysis as another set of inputs (S3). The matching server matches the above inputs from the terminal devices to the inputs from the surveillance camera, and specifies the target user's particular terminal device (S4). Ad information corresponding to that user's attributes as determined from an image, or information on the user's position, for example, is then issued to the target user's terminal device as a push notification (S5).

(1-2. Acquisition of Motion Information from Sensor)

Next, the acquisition of motion information from a sensor according to the present embodiment will be described. As described above, the present embodiment acquires a user's motion information from an acceleration sensor in a terminal device. Thus, the acquisition of motion information using an acceleration will be described in detail with the example shown below.

Note that various sensors, such a gyro sensor or a barometric pressure sensor, may be used as the sensor used to acquire motion information in a terminal device. Furthermore, these sensors may also be used in conjunction with an acceleration sensor. Note that a barometric pressure sensor is a sensor capable of acquiring information regarding the altitude of a terminal device by measuring air pressure.

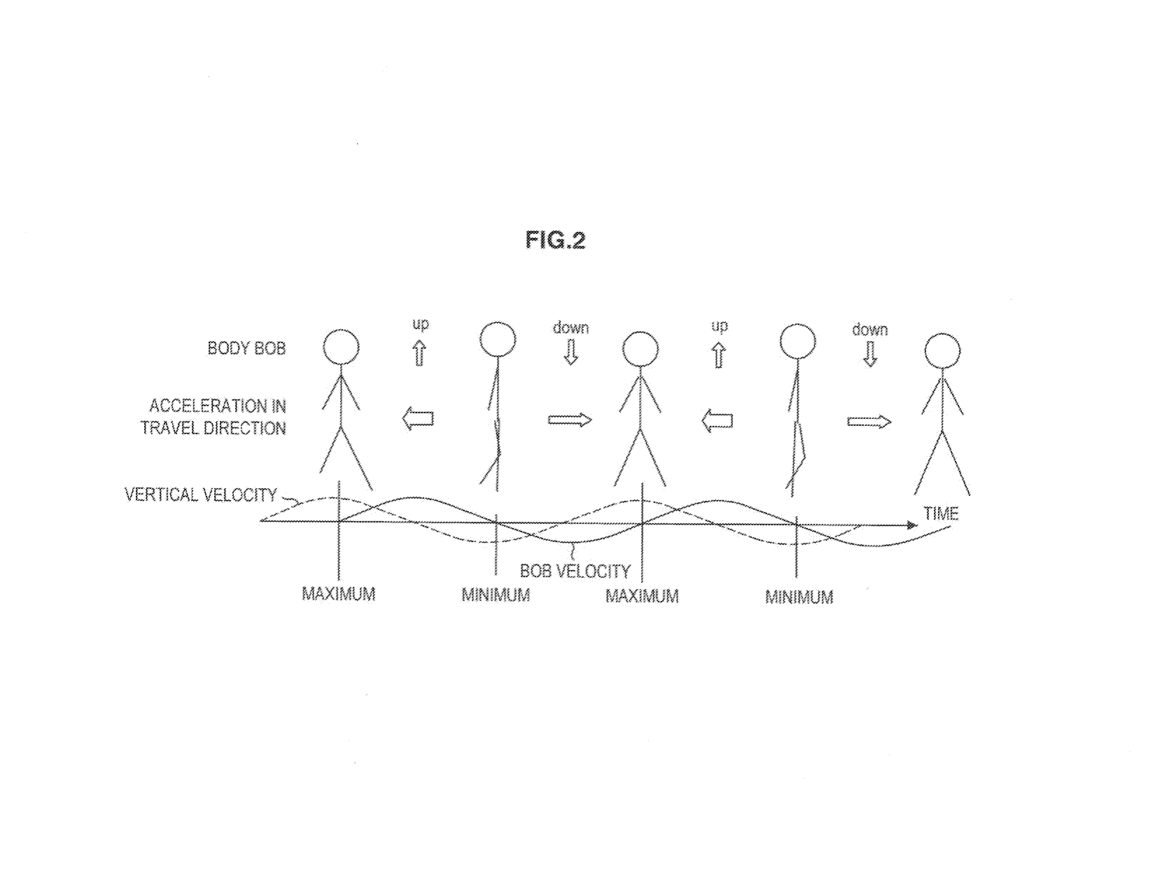

FIG. 2 is a figure illustrating motion information acquisition using acceleration according to the first embodiment of the present disclosure. As illustrated in FIG. 2, the present embodiment detects a user's walking behavior from the output of an acceleration sensor.

Herein, attention will focus on the acceleration in the up-and-down motion (bob) and travel direction of the user's body during walking behavior. Regarding bob, the point in time at which both legs are together and the head has fully risen (or the point in time at which one leg is stepping forward and the head has fully lowered) is specified as the point in time at which acceleration in the vertical direction reaches a minimum. Consequently, in the case where measurement results from an acceleration sensor in a terminal device indicate a user's walking behavior, it is possible to associate a user appearing in an image with a user carrying a terminal device by matching, on a time axis, the points in time at which acceleration in the vertical direction reaches a minimum (walking behavior feature points detected by a sensor) to the points in time at which both of a user's legs are together and the head has fully risen as detected by analyzing images of a user exhibiting walking behavior in camera images (walking behavior feature points detected from images).

Alternatively, since one-step time intervals in the walking behavior are respectively specified from acceleration sensor measurement results and image analysis results, these time intervals may be matched to associate a user appearing in an image with a user carrying a terminal device.

Meanwhile, regarding acceleration in the travel direction, if a user steps forward with his or her leg, acceleration increases due to the user's body leaning forward, whereas the acceleration shifts to decreasing when the leg stepping forward touches the ground. With such acceleration in the travel direction, it is likewise possible to match walking behavior feature points on a time axis, similarly to the case of the above acceleration in the vertical direction. For example, it is possible to association a user appearing in an image with a user carrying a terminal device by matching, on a time axis, the points in time at which the acceleration in the travel direction reaches a maximum (points where the acceleration shifts to decreasing) to the points in time at which the user's leg, stepping forward, touches the ground. Alternatively, one-step time intervals in the walking behavior may likewise be specified from acceleration in the travel direction, and matching by time intervals may be executed.

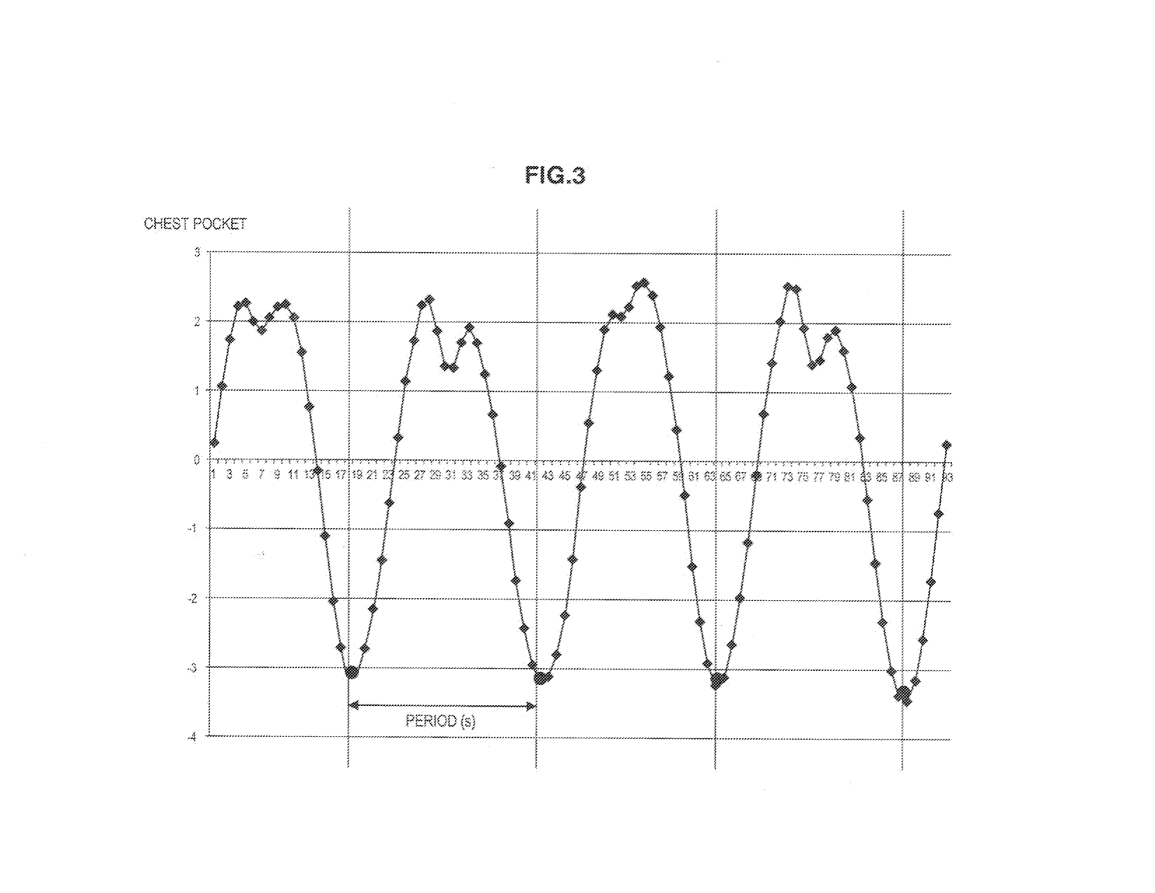

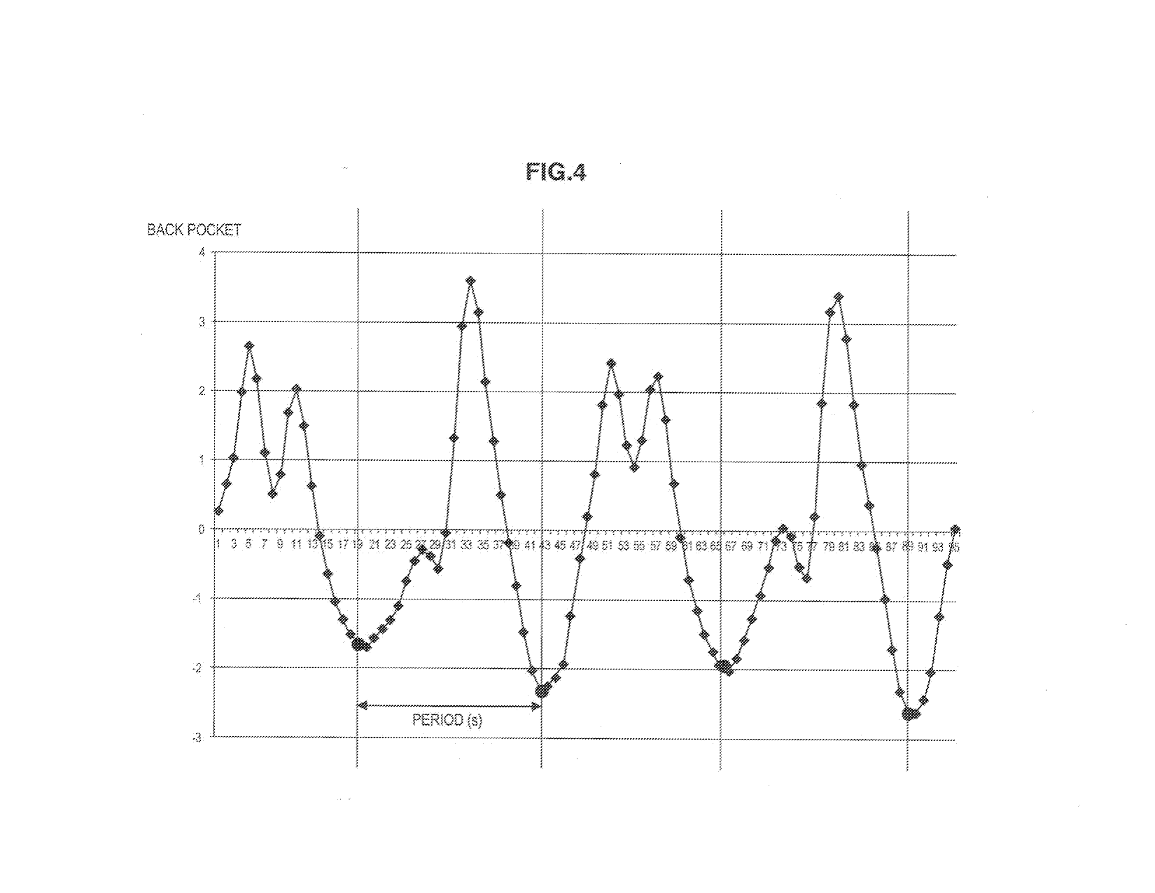

FIGS. 3 and 4 are figures illustrating examples of acceleration information which may be used according to the first embodiment of the present disclosure.

FIG. 3 illustrates an example of acceleration in the vertical direction for the case where the user has inserted a terminal device into a chest pocket. In the case where a terminal device is being carried on the upper body, such as in a chest pocket, the acceleration waveforms are nearly the same for the case of stepping forward with the right leg and the case of stepping forward with the left leg while walking.

Meanwhile, FIG. 4 is an example of acceleration for the case where the user has inserted a terminal device into a back pocket. In the case where a terminal device is being carried on the lower body, such as in a back pocket, the acceleration waveforms differ between the case of stepping forward with the right leg and the case of stepping forward with the left leg while walking.

However, since the feature points where the acceleration reaches a minimum clearly appear in both cases illustrated in FIGS. 3 and 4, it is possible to extract the one-step time interval (period) and the phase where the acceleration in the vertical direction reaches a minimum, regardless of whether the right leg is stepping forward or the left leg is stepping forward.

Also, as described above, there are differences in waveform trends between the case of carrying a terminal device on the upper body and the case of carrying a terminal device on the lower body. Furthermore, if information on whether or not a display unit (such as an LCD) of a terminal device is activated were to be used, it is conceivably possible to determine whether or not a user is walking while viewing a display on the terminal device. Using these differences, information may be transmitted to a user who, from information such as the carry position of his or her terminal device, is estimated to have a high probability of noticing transmitted ad or other information and viewing the information immediately, for example. Moreover, the extraction of behavioral feature points is not limited to the case of a periodic behavior such as the above. For example, transient behaviors such as stopping in place or taking out a terminal device may also be extracted as feature points.

(1-3. Specific Example of Matching)

Next, a specific example of a process that matches behavior information acquired from a sensor and behavior information acquired by analyzing an image as above will be further described. Note that since it is possible to use established image analysis techniques for the process of acquiring behavior information by analyzing an image, detailed description thereof will be reduced or omitted.

As an example, data on time points at which vertical acceleration reaches a minimum in respective terminal devices (terminal A, terminal B, and terminal C) may be acquired as below from analysis results regarding acceleration in the vertical direction acquired from the acceleration sensor in each terminal device.

Terminal A

| | |
|---|---|
| TAₙ | hh:mm:ss:mmm |
| TAₙ₊₁ | hh:mm:ss:mmm |
| TAₙ₊₂ | hh:mm:ss:mmm |

Terminal B

| | |
|---|---|
| TBₙ | hh:mm:ss:mmm |
| TBₙ₊₁ | hh:mm:ss:mmm |
| TBₙ₊₂ | hh:mm:ss:mmm |

Terminal C

| | |
|---|---|
| TCₙ | hh:mm:ss:mmm |
| TCₙ₊₁ | hh:mm:ss:mmm |
| TCₙ₊₂ | hh:mm:ss:mmm |

Meanwhile, data on time points at which a user's head is fully raised or at which both of a user's legs are together may be acquired as below from image analysis of a target user.

Target Use in Image

| | |
|---|---|
| Tₙ | hh:mm:ss:mmm |
| Tₙ₊₁ | hh:mm:ss:mmm |
| Tₙ₊₂ | hh:mm:ss:mmm |

In the matching process, the time data having the least difference from the time data acquired from an image is specified from among the time data acquired from each terminal device, and the terminal device providing the least different time data is specified as the terminal device being carried by the target user. Specifically, the matching process may calculate differential error values ErrA to ErrC as follows, and search for the terminal device with the smallest differential error value, for example.

$$Err A = \text{?} {( \text{?} - \text{?} )}^{2}$$

$$Err B = \text{?} {( \text{?} - \text{?} )}^{2}$$

$$Err C = \text{?} {( \text{?} - \text{?} )}^{2}$$

$$\text{?} \text{indicates text missing or illegible when filed}$$

However, since a situation may occur in which a user carrying a terminal device that is providing information does not appear in an image in some cases, a “not found” determination may also be made when the differential error values are greater than a predetermined threshold.

The above time data preferably uses a common standard such as Coordinated Universal Time (UTC) to avoid accidental errors, but factors such as unsynchronized clocks in each device may produce accidental errors in the time points in some cases. In such cases, the above differential error values may also be computed with the addition of an accidental error value δ as follows.

$$Err A = \text{?} {( \text{?} - \text{?} + \text{?} )}^{2}$$

$$Err B = \text{?} {( \text{?} - \text{?} + \text{?} )}^{2}$$

$$Err C = \text{?} {( \text{?} - \text{?} + \text{?} )}^{2}$$

$$\text{?} \text{indicates text missing or illegible when filed}$$

The accidental error δ is set for each of the terminals A to C. First, the accidental errors δ_{A}, δ_{B}, and δ_{C} are varied over a range of accidental error which may be present in the timestamp of the information transmitted from each terminal device, and the accidental errors δ_{A}, δ_{B}, and δ_{C} are set so as to minimize the differential errors ErrA, ErrB, and ErrC, respectively. However, since the possibility of mistakenly matching each terminal device to the wrong user also exists, it is preferable to attach a timestamp shared by the sensor detection results from the terminal devices and the acquired image data if possible.

Note that although the examples in the above FIGS. 2 to 4 introduce an example where the user's walking behavior is steady, such behavior will not necessarily be the target of matching. For example, unsteady behavior, such as the user stopping in place, changing direction, and starting to walk again, may also be the target of matching. However, such behaviors are actually easier to match in some cases, as feature points such as start points and end points are easy to extract.

The example of matching described above is merely one example, and different matching processes may be executed in other embodiments of the present disclosure. Matching processes according to other embodiments may include various established matching processes, such as processes that compute correlation coefficients, for example.

(1-4. System Configuration for Providing Service)

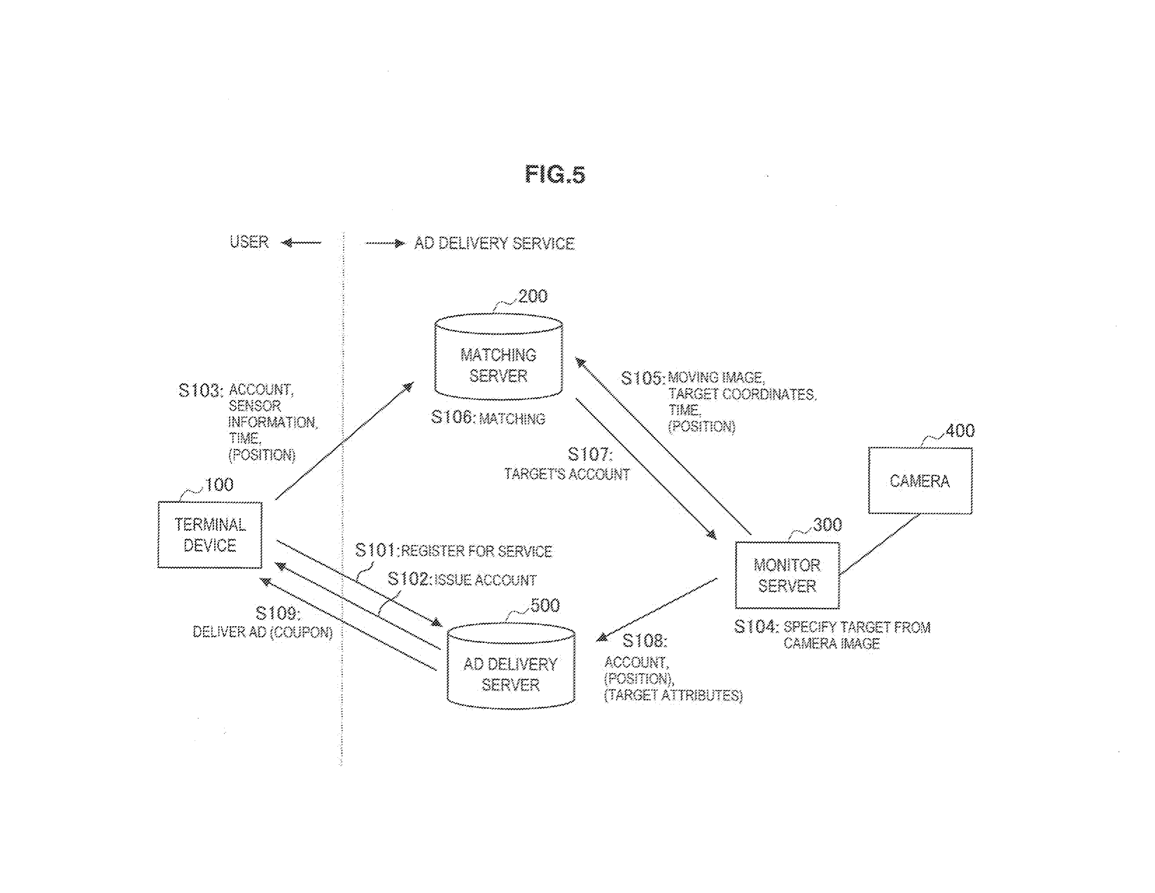

FIG. 5 is a figure illustrating a diagrammatic system configuration for providing an ad delivery service according to the first embodiment of the present disclosure. The system includes a terminal device 100, a matching server 200, a monitor server 300, a camera 400, and an ad delivery server 500. Hereinafter, the operation of each component of the system will be successively described.

Note that the terminal device 100 may be a device such as a mobile phone (including a smartphone) or tablet personal computer (PC) carried by the user, and may be realized using the hardware configuration of an information processing apparatus discussed later. The matching server 200, the monitor server 300, and the ad delivery server 500 may be realized by one or multiple server devices on a network. For example, a single server device may collectively realize the functions of each server, or the functions of each server may be realized by being further distributed among multiple server devices. The individual server devices may be realized using the hardware configuration of an information processing apparatus discussed later. Also, in the case of multiple server devices, each server device is connected to various networks in a wired or wireless manner (this applies similarly to other servers in the other embodiments of the present disclosure described hereinafter).

First, service registration (S101) and account issuing (S102) are executed between the terminal device 100 and the ad delivery server 500. This involves the user of the terminal device 100 registering in order to utilize an ad delivery service based on matching as discussed earlier. With this registration, the terminal device 100 provides the matching server 200 with account information and sensor information for behavior information extracted from sensor information), together with time information (a timestamp) (S103).

Note that the service registration in S101 is not for the purpose of using the account information to identify the user. Consequently, with this registration, personal information such as an image of the user's face may not be registered. It is sufficient for the information provided by the user to the ad delivery server 500 to at least include a destination for the ad delivery discussed later (such as an email address, a device ID, or a push notification token).

Also, in S103, the sensor information may provide the matching server 200 with general position information in addition to the account information and time information from the terminal device 100. Such information may be information indicating the rough position of the terminal device, such as “in a shopping mall”, for example, and may be acquired by positioning using the Global Positioning System (GPS), a Wireless Fidelity (Wi-Fi) access point, or a mobile phone base station, for example. In so doing, the matching server 200 is able to limit, to a certain extent, the users who may be present within the range where an image is acquired by the camera 400 (for example, in the case where the camera 400 is installed in a shopping mall, the terminal devices of users who are not in the shopping mall may be excluded from matching), thereby potentially reduce the processing load for matching.

Meanwhile, the camera 400 provides the monitor server 300 with an image. In the monitor server 300, a user such as a shop who is the ad subject specifies a target user by viewing the image and selecting a user thought to be a desirable recipient of a delivered ad (S104). Alternatively, a target user may be automatically selected by filtering the user positions obtained by analyzing the image (such as near the shop) or user attributes (such as gender and age, for example) according to parameters set in advance by the user who is the ad subject.

When a target user is specified, the monitor server 300 provides the matching server 200 with the image (moving image) provided by the camera 400, the in-image coordinates of the specified target user, and information on the time when the image was acquired (S105). At this point, the monitor server 300 may additionally provide the matching server 200 with information on the position of the camera 400. For example, in the case where multiple cameras 400 are installed, providing the matching server 200 with position information indicating where the particular camera is installed makes it possible to limit the targets of matching in conjunction with the above general position information provided by the terminal device 100, thus potentially reducing the processing load. Note that in another embodiment, the monitor server 300 may execute the image analysis and provide the matching server 200 with extracted behavior information.

The matching server 200 executes matching on the basis of the sensor information from the terminal device 100 provided in S103, and the image information provided in S105 (S106). As a result of the matching, the account information of the terminal device 100 corresponding to the target user specified in the image is extracted. The matching server 200 provides the monitor server 300 with the target user's account information (S107).

The monitor server 300 provides the ad delivery server 500 with the target user's account information, and request the delivery of an ad (S108). At this time, information on the target user's position and attributes may be additionally provided in the case where the target user was automatically selected in accordance with user positions and attributes, for example. The ad delivery server 500 delivers an ad to the user in accordance with the information provided by the monitor server 300 (S109). The ad may include a coupon.

(Modification)

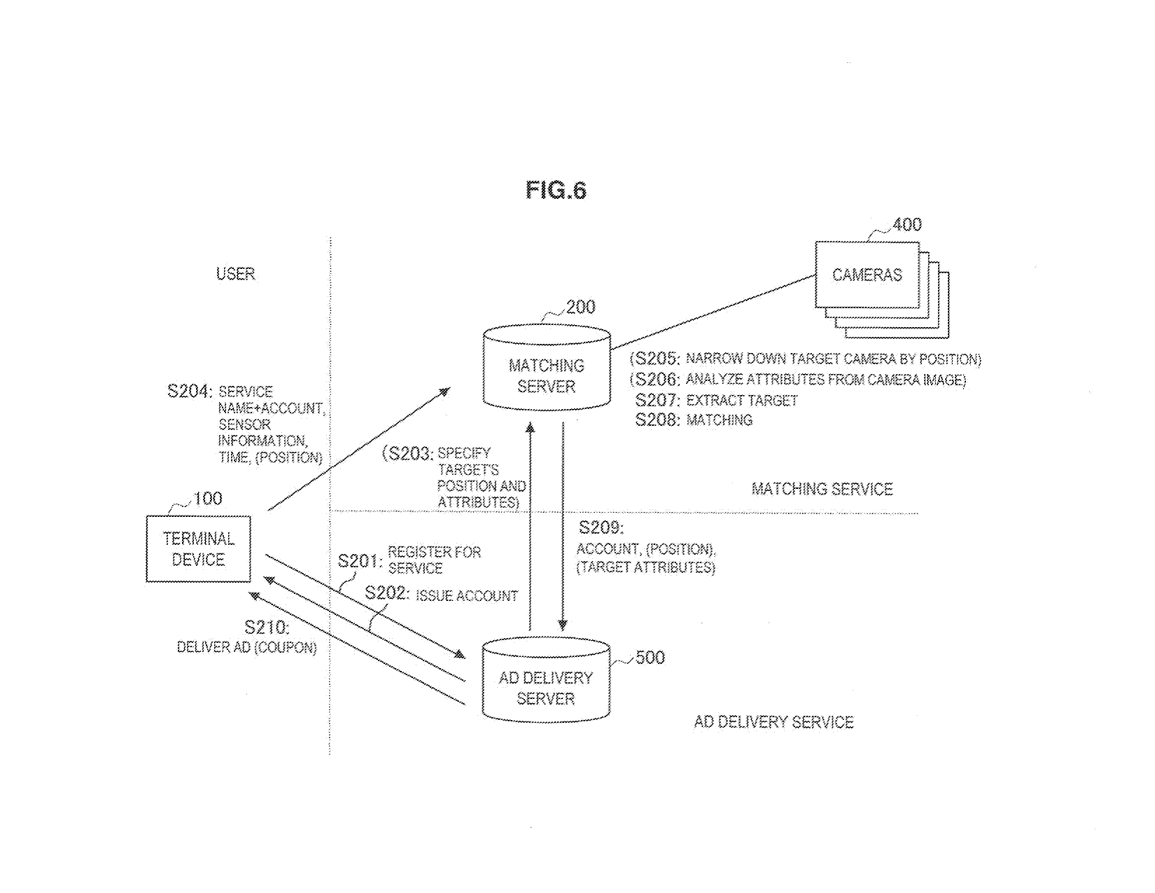

FIG. 6 is a figure illustrating a modification of a diagrammatic system configuration for providing an ad delivery service according to the first embodiment of the present disclosure. Whereas in the above example in FIG. 5, a matching server 200, a monitor server 300, a camera 400, and an ad delivery server 500 are included in a special-purpose ad delivery system, in the example in FIG. 6, a system including a matching server 200 and a camera 400 exists as a general-purpose matching service not limited to ad delivery, and this system is utilized by an ad delivery server 500. Hereinafter, the operation of each component of the system will be successively described.

First, service registration (S201) and account issuing (S202) are executed between the terminal device 100 and the ad delivery server 500. This is information for the purpose of the user of the terminal device 100 receiving an ad delivery service based on matching. Meanwhile, the ad delivery server 500 provides the matching server 200 in advance with information specifying the positions and attributes of a target user for ad delivery (S203). For example, the information indicating positions and attributes provided at this point may be information indicating where and what kind of user should receive an ad, such as “male, twenties, in front of shop B in shopping mall A”.

The terminal device 100 provides the matching server 200 with a service name corresponding to the ad delivery server 500, account information, and sensor information (or behavior information extracted from sensor information), together with time information (a timestamp) (S204). Service name information is provided together with account information at this point because the matching service is provided as a general-purpose service, which may be used for services other than the service provided by the ad delivery server 500. With this service name information, for example, the matching server 200 associates sensor information transmitted from the terminal device 100 with target user information provided by the ad delivery server 500. Note that the terminal device 100 may likewise provide the matching server 200 with general position information at this point, similarly to the above example in FIG. 5.

The matching server 200 may also narrow down to a camera for matching from among multiple cameras 400, according to information specifying the target user's position provided by the ad delivery server in S203 (S205). In addition, the matching server may analyze the attributes of users appearing in an image from a camera 400 (S206), and compare the attributes against information on the target user's attributes provided by the ad delivery server. In so doing, for example, the matching server 200 extracts the target user from among users appearing in an image from the camera 400 (S207).

The matching server 200 matches the extracted target user on the basis of sensor information from the terminal device 100 provided in S204, and information on the image acquired by the processes up to S207 (S208). As a result of the matching, the account information of the terminal device 100 corresponding to the target user is extracted. The matching server 200 provides the target user's account information to the ad delivery server 500 (S209). At this time, information on the target user's position and attributes may be additionally provided in the case where information on multiple positions and attributes is provided in S203, for example. The ad delivery server 500 delivers an ad to the user in accordance with the information provided by the matching server 200 (S210). The ad may include a coupon.

(1-5. Functional Configuration of Each Device)

Next, a functional configuration of each device in the system of the above FIG. 5 or 6 will be described. As discussed above, the functional configuration of each device described hereinafter may be realized by information processing apparatus configured as a system.

(Terminal Device)

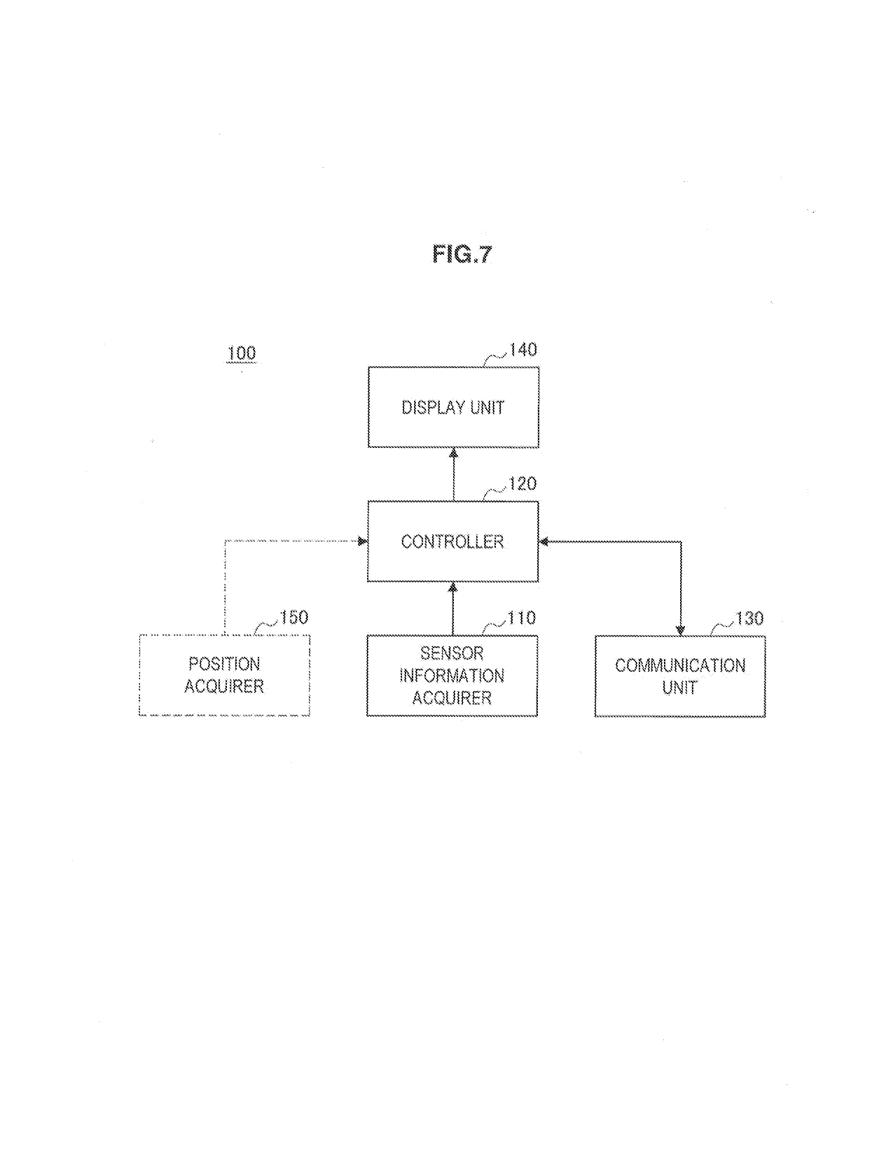

FIG. 7 is a block diagram illustrating a schematic functional configuration of a terminal device according to the first embodiment of the present disclosure. As illustrated in FIG. 7, the terminal device 100 includes a sensor information acquirer 110, a controller 120, a communication unit 130, and a display unit 140. The terminal device 100 may additionally include a position acquirer 150.

The sensor information acquirer 110 includes various sensors that indicate user behavior. The sensors may be an acceleration sensor, a gyro sensor, a barometric pressure sensor, a geomagnetic sensor, and a camera, for example. Of these, the acceleration sensor and the gyro sensor detect changes in the acceleration and angular velocity of the terminal device 100 due to user behavior. Also, the barometric pressure sensor detects changes in the altitude of the terminal device 100 due to user behavior, according to changes in air pressure. The geomagnetic sensor and the camera acquire information such as the orientation of the user's head and an image of the user's field of vision in cases such as where the terminal device 100 is head-mounted, for example.

The controller 120 is realized in software using a central processing unit (CPU), for example, and controls the functional configuration of the terminal device 100 illustrated in FIG. 7. The controller 120 may be an application program installed on the terminal device 100 for the purpose of utilizing an ad delivery service, for example. In another embodiment, the controller 120 may also analyze sensor information acquired by the sensor information acquirer 110 and extract user behavior information.

The communication unit 130 is realized by a communication device, for example, and communicates with the matching server 200 or the ad delivery server 500 in a wired or wireless manner via various networks. For example, the communication unit 130 may transmit and receive account information applied for and issued for service registration with the ad delivery server 500. The communication unit 130 may also transmit sensor information acquired by the sensor information acquirer 110 to the matching server 200 (in another embodiment, user behavior information obtained by analyzing sensor information may also be transmitted). In addition, the communication unit 130 receives ad delivery, information transmitted from the ad delivery server 500 according to matching results.

The display unit 140 is realized by various displays, for example, and presents various information to the user. For example, the display unit 140 may display ad information received from the ad delivery server 500 via the communication unit 130. In another embodiment, an audio output unit may be provided together with, or instead of, the display unit 1410, and output ad information to the user via sound.

The position acquirer 150 is provided in the case of the terminal device 100 providing general position information to the matching server as described earlier. Position information may be acquired by positioning using GPS, a Wi-Fi access point, or a mobile phone base station, for example. Alternatively, position information may be acquired by positioning using radio-frequency identification (RFID), the Indoor Messaging System (MUTES), or a Bluetooth (registered trademark) access point. Furthermore, by transmitting not just the positioning results, but also a positioning precision index and information on the positioning method, the matching server 200 is able to execute a matching process that takes into account the precision of the position information from the terminal device 100. In this case, a wider range may be set for the camera 400 corresponding to the position information for a terminal device 100 with imprecise position information, for example.

Note that the transmitting of position information from the terminal device 100 to the matching server 200 is not strictly necessary. In the case of providing service over a wide area, there may be many cameras 400 and terminal devices 100 for matching, and thus having the terminal device 100 transmit position information is effective. However, in another embodiment, position information may also not be transmitted from the terminal device 100 to the matching server 200 in the case of a limited area or number of target users, for example.

(Matching Server)

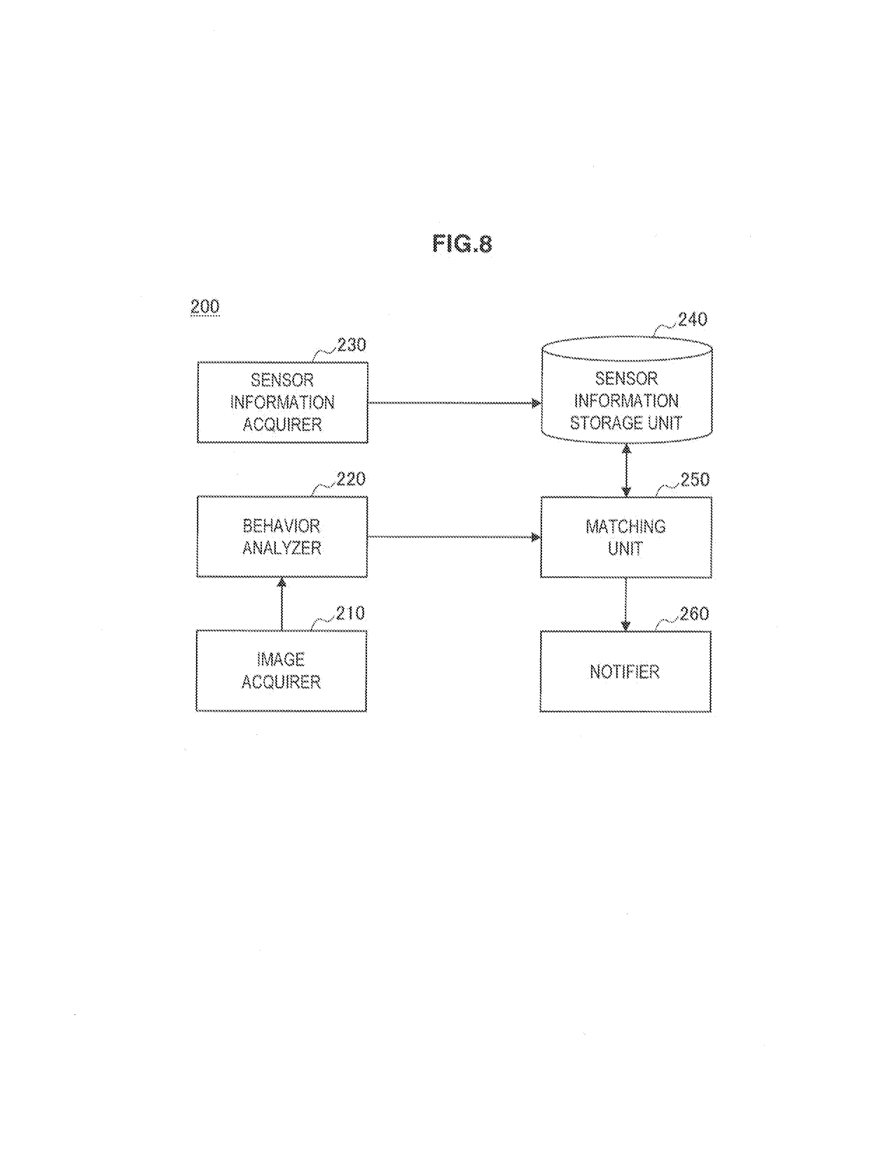

FIG. 8 is a block diagram illustrating a schematic functional configuration of a matching server according to the first embodiment of the present disclosure. As illustrated in FIG. 8, the matching server 200 includes an image acquirer 210, a behavior analyzer 220, a sensor information acquirer 230, a sensor information storage unit 240, a matching unit 250, and a notifier 260. Note that the respective units other than the sensor information storage unit 240 may be realized in software using a CPU, for example.

The image acquirer 210 acquires an image (moving image) from the monitor server 300 (or the camera 400). As described earlier, in the case where a terminal device 100 transmits position information and a camera 400 to use for matching is selected in accordance with the position information, the image acquired by the image acquirer 210 may be an image from the selected camera 400. In addition, the image acquirer 210 acquires, along with the image, information specifying a target user in the image. The target user may be specified by in-image coordinates, for example.

The behavior analyzer 220 analyzes the image acquired by the image acquirer 210 to analyze the behavior of the target user. As discussed earlier, various established techniques may be applied as the image analysis technique used herein. In the above case of walking behavior, for example, the behavior analyzer 220 uses analysis to extract information such as time points at which the target user's head is fully risen, or at which both of the target user's legs are together. In this way, since the behavior information acquired by the behavior analyzer 220 is matched to behavior information based on sensor output acquired by the sensor information acquirer 230 discussed later, the behavior information acquired by the behavior analyzer 220 may be information indicating feature points for behavior that is also detectable from the sensor output. The information acquired by the behavior analyzer 220 may be referred to as first behavior information indicating user behavior, which is detected by analysis of an image in which the user appears.

The sensor information acquirer 230 acquires sensor information from the terminal device 100. As described for the terminal device 100, the sensor information is acquired using sensors such as an acceleration sensor, a gyro sensor, a barometric pressure sensor, a geomagnetic sensor, and a camera, for example. The sensor information acquirer 230 may acquire output from these sensors continuously, but may also acquire output discretely as a timestamp array of feature points, as in the earlier example of walking behavior. The information acquired by the sensor information acquirer 230 may be referred to as second behavior information indicating user behavior, which is detected from the output of sensors in a terminal device that the user is carrying.

The sensor information storage unit 240 stores the sensor information acquired by the sensor information acquirer 230. In the present embodiment, since a target user in the image is specified, the first behavior information detected by the behavior analyzer 220 is taken to be correct, so to speak. In contrast, the sensor information acquirer 230 acquires sensor information from the terminal devices 100 of multiple users as the second behavior information, which is matched to the first behavior information. Consequently, sensor information from the terminal devices of multiple users may be at least temporarily accumulated. Note that the memory that temporarily stores information such as the information of an image acquired by the image acquirer 210 and information generated during the processing by the behavior analyzer 220 or the matching unit 250 is provided separately from the sensor information storage unit 240.

The matching unit 250 matches the first behavior information acquired by the behavior analyzer 220 to the second behavior information acquired by the sensor information acquirer 230 and stored in the sensor information storage unit 240, and identifies relationships between users and terminal devices 100. For example, the matching unit 250 may match feature points respectively indicated by the first behavior information and the second behavior information on a time axis, as in the earlier example of walking behavior. In addition, other examples of matching besides the above are also possible, depending on the type of sensor information. Hereinafter, several such examples will be described.

For example, in the case where the sensor information includes the output from a barometric pressure sensor, the behavior analyzer 220 estimates the altitude of the target user by image analysis, and provides the matching unit 250 with information on the estimated altitude as part of the first behavior information. The matching unit 250 may match the target user's altitude estimated from an image to the altitude detected by the barometric pressure sensor of a terminal device 100. Such matching may be particularly effective in the case where the image acquired by the image acquirer 210 captures a location with altitude differences such stairs, escalators, or an atrium, for example.

As another example, in the case where the sensor information includes the output from a geomagnetic sensor, the behavior analyzer 220 specifies the orientation of the target user's head by image analysis, and provides the matching unit 250 with that information as part of the first behavior information. The matching unit 250 matches the orientation of the target user's head specified from an image to the orientation of a user's head detected by the geomagnetic sensor of a terminal device 100 (a head-mounted device, for example).

As another example, in the case where the sensor information includes an image of the user's field of vision acquired by a camera, the behavior analyzer 220 estimates the direction in which the user is looking by image analysis, and provides the matching unit 250 with the estimated information as part of the first behavior information. Information indicating what is visible when looking in a particular direction in the image, for example, may be provided to the matching unit 250 in advance for the purpose of such analysis. Alternatively, the matching unit 250 may acquire the results of recognizing a feature such as another user in the image as an object from the behavior analyzer 220, and match that object to an image contained in the user's field of vision.

The notifier 260 issues the target user's account information to the monitor server 300 or the ad delivery server 500 on the basis of the results of the matching in the matching unit 250. As discussed earlier, the issued information may also contain information on the target user's position and attributes.

(Monitor Server)

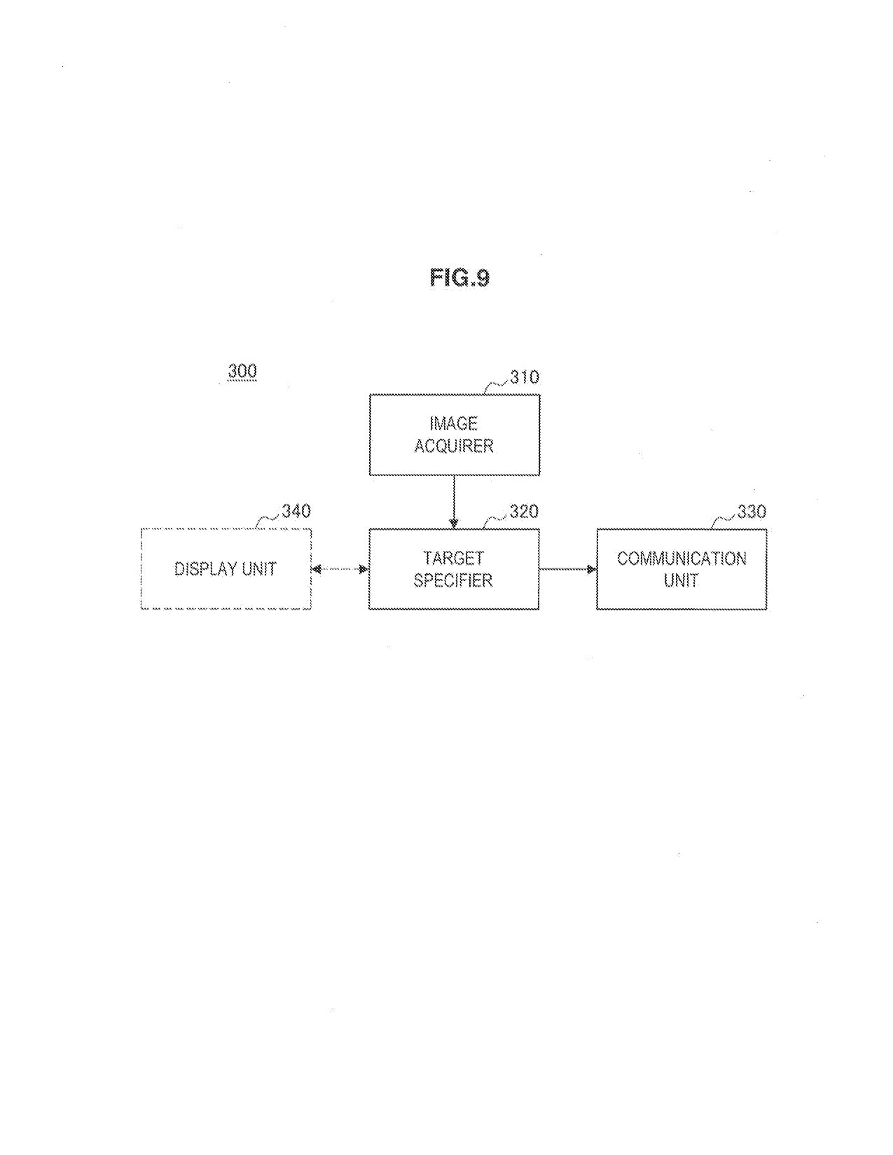

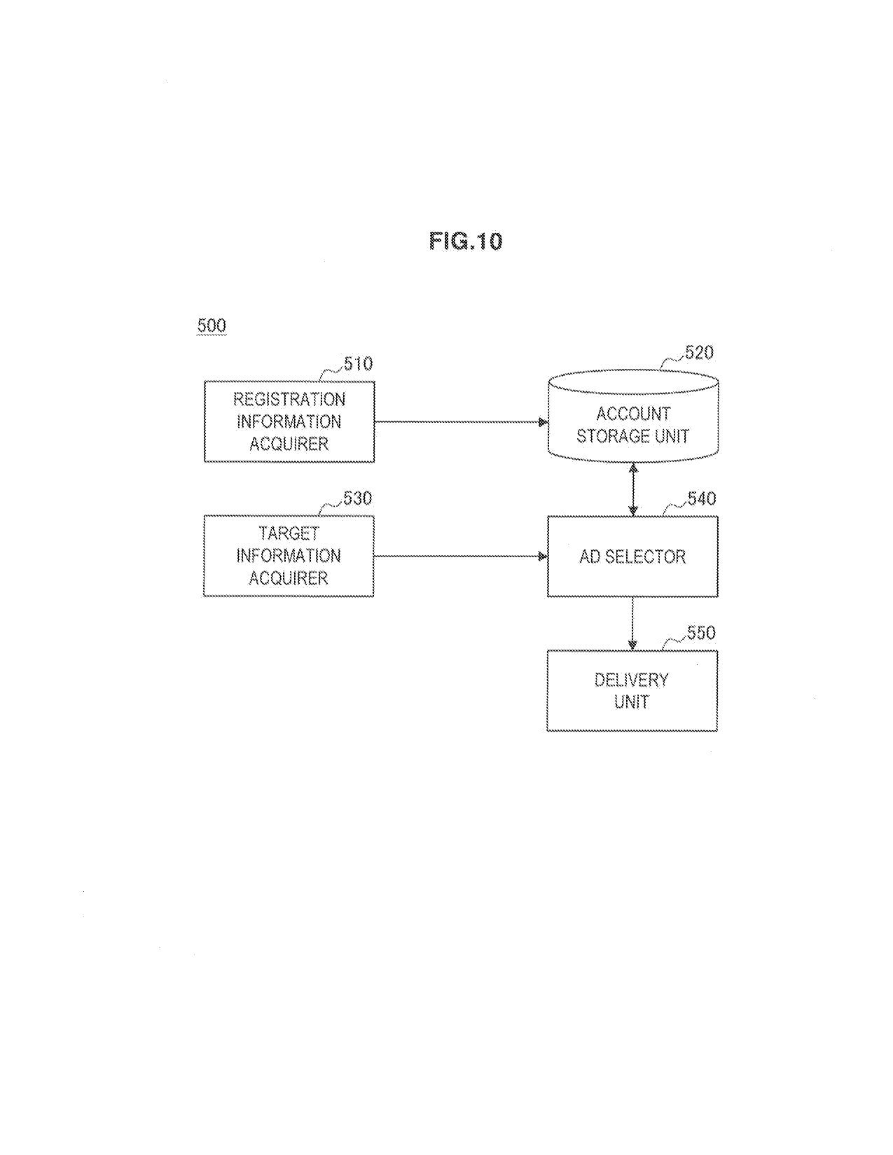

FIG. 9 is a block diagram illustrating a schematic functional configuration of a monitor server according to the first embodiment of the present disclosure. As illustrated in FIG. 10, the monitor server 300 includes an image acquirer 310, a target specifier 320, and a communication unit 330. The monitor server 300 may additionally include a display unit 340. Note that the image acquirer 310 and the target specifier 320 may be realized in software using a CPU, for example.

The image acquirer 310 acquires an image (moving image) from the camera 400. In the case of multiple cameras 400, the particular camera 400 from which to acquire an image may be selectable via the display unit 340 discussed later.

The target specifier 320 specifies a target user from among the users appearing in the image acquired by the image acquirer 310. The target user may be automatically specified in some cases, and specified by a user operation in other cases. In the case of automatically specifying the target user, the target specifier 320 may analyze the image acquired by the image acquirer 310 and acquire the positions (such as near a shop) and attributes (such as gender and age, for example) of users appearing in the image, for example. The target specifier 320 may then filter the users in the image on the basis of these positions and attributes according to parameters set in advance by the user who is the ad subject, and specify a target user. Alternatively, the target specifier 320 may detect the users appearing in the image and set all detected users as target users.

Meanwhile, in the case of specifying a target user by a user operation, the target specifier 320 provides the display unit 340 with the image acquired by the image acquirer 310, and specifies a target user in accordance with a user operation acquired via, the display unit 340. In either of the above cases, information on the specified target user may be provided to the matching server 200 via the communication unit 330 as in-image coordinate information, for example.

The communication unit 330 is realized by a communication device, for example, and communicates with the matching server 200 and the ad delivery server 500 in a wired or wireless manner via various networks. For example, the communication unit 330 may transmit the image acquired by the image acquirer 310 and information indicating the target user specified by the target specifier 320 to the matching server 200. In addition, the communication unit 330 receives, from the matching server 200, account information for the terminal device 100 being carried by the target user specified as a result of matching. Additionally, the communication unit 330 transmits the target user's account information to the ad delivery server 500 as an ad delivery request. At this point, the communication unit 330 may transmit additional information on the target user's position and attributes.

The display unit 340 is provided in the case where a target user in an image is specified by an operation by the user who is the ad subject, for example. The display unit 340 is realized by various displays, for example, and presents various information to the user. For example, the display unit 340 may display the image acquired by the image acquirer 310. An input unit such as a touch panel be attached to the display unit 340, and this input unit may be used to perform an input operation that specifies a target user from among the users appearing in an image. The display unit 340 may also display a graphical user interface (GUI) used to perform the operation of specifying a target user as above.

(Ad Delivery Server)

FIG. 10 is a block diagram illustrating a schematic functional configuration of an ad delivery server according to the first embodiment of the present disclosure. As illustrated in FIG. 10, the ad delivery server 500 includes a registration information acquirer 510, an account storage unit 520, a target information acquirer 530, an ad selector 540, and a delivery unit 550. Note that the respective units other than the account storage unit 520 may be realized in software using a CPU, for example.

The registration information acquirer 510 accepts registrations by communication with the terminal device 100 for the purpose of the user of the terminal device 100 using an ad delivery service. Accepted registration information is recorded to the account storage unit 520, and referenced by the ad selector 540 when the user of the terminal device 100 is specified as the target user by matching. The registration information may include information regarding a destination for ad delivery (such as an email address, a device ID, or a push notification token), for example.

The target information acquirer 530 acquires, from the monitor server 300 (or the matching server 200), account information for the terminal device 100 of the target user specified as a result of matching. At this point, the target information acquirer 530 may also receive additional information on the target user's position and attributes.

The ad selector 540 selects an ad to deliver in accordance with the information acquired by the target information acquirer 530. The ad to deliver may be a preset ad, but may also be selected according to information on the target user's position and attributes acquired by the target information acquirer 530. The ad selector 540 may reference the account storage unit 520 and acquire information regarding a destination for pushing ad information to the terminal device 100 (such as an email address, a device ID, or a push notification token).

The delivery unit 550 delivers the ad selected by the ad selector 540 by pushing information to the target user's terminal device. As described above, the information to be delivered may also contain information such as a coupon in addition to an ad.

The foregoing thus describes the first embodiment of the present disclosure. Note that in this embodiment, and in the other embodiments described hereinafter, the configuration may be designed appropriately according to factors such as the capability of each device, for example, such that an image and sensor output are provided to the matching server 200 directly as data, or provided to the matching server 200 as behavior information obtained by analysis executed in the monitor server, camera, or terminal device. Consequently, the behavior information acquired at the matching server 200 is not strictly limited to being information that the matching server 200 itself has extracted by analyzing an image and sensor output.

### 2. Second Embodiment

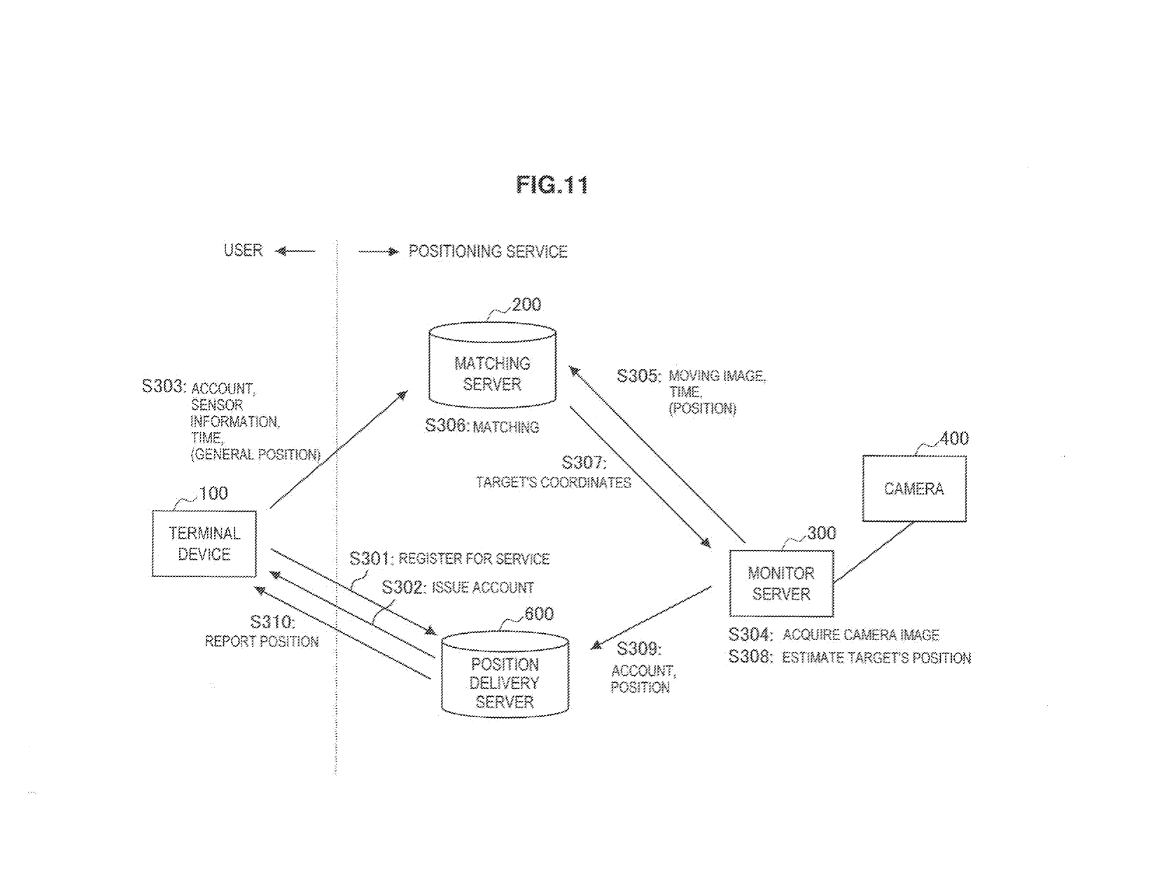

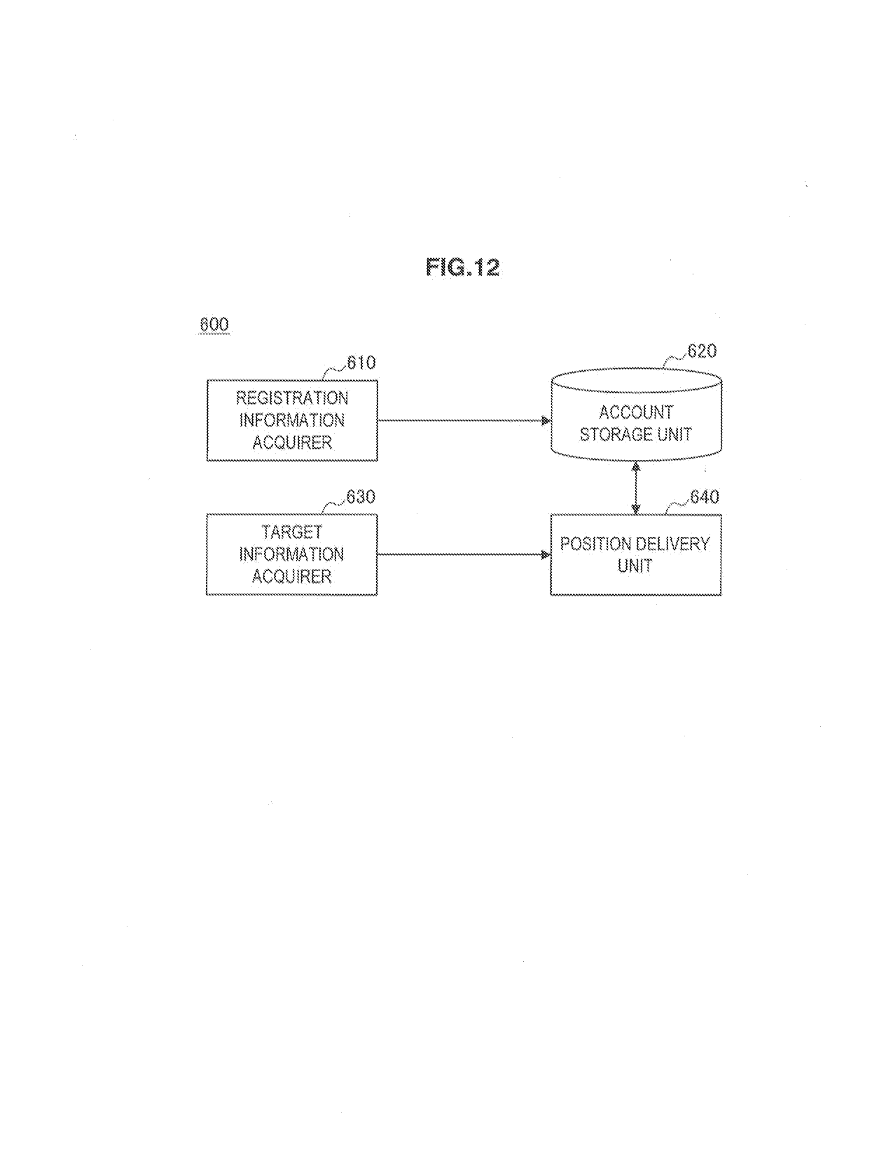

Next, the second embodiment of the present disclosure will be described with reference to FIGS. 11 and 12. In this embodiment, a target user requesting a position information notification from a terminal device being carried is specified from among the users appearing in an image from a surveillance camera or other camera, and position information recognized from the image is transmitted to the terminal device. In so doing, it is possible to provide a user with precise position information, even in places such as indoor locations where obtaining precise position information is difficult with other methods.

Note that this embodiment may share some points in common with the foregoing first embodiment, such as the acquisition of user behavior information and the matching of behavior information. Thus, detailed description of these points will be reduced or omitted,

(2-1, System Configuration for Providing Service)

FIG. 11 is a figure illustrating a diagrammatic system configuration for providing a positioning service according to the second embodiment of the present disclosure. The system includes a terminal device 100, a matching server 200, a monitor server 300, a camera 400, and a position delivery server 600. Hereinafter, the operation of each component of the system will be successively described.

First, service registration (S301) and account issuing (S302) are executed between the terminal device 100 and the position delivery server 600. This involves the user of the terminal device 100 registering in order to utilize a positioning service based on matching as discussed earlier. With this registration, the terminal device 100 provides the matching server 200 with account information and sensor information (or behavior information extracted from sensor information), together with time information (a timestamp) (S303).

Note that, similarly to the first embodiment, the service registration in S301 is not for the purpose of using the account information to identify the user. Consequently, with this registration, personal information such as an image of the user's face may not be registered. It is sufficient for the information provided by the user to the position server 600 to at least include a destination for the position discussed later (such as an email address, a device ID, or a push notification token).

Also, in S103, the sensor information may provide the matching server 200 with general position information in addition to the account information and time information from the terminal device 100. Such information may be information indicating the rough position of the terminal device, such as “in a shopping mall”, for example, and may be acquired by positioning using GPS, a Wi-Fi access point, or a mobile phone base station, for example. Doing so may potentially reduce the processing load for matching, similarly to the first embodiment. Note that the position information later delivered from the position delivery server 600 to the terminal device 100 is much more detailed position information than the general position information transmitted at this point.

Meanwhile, the monitor server 300 acquires an image from the camera 400 (S304). Unlike the case of the first embodiment, at this point the question of which user appearing in the image is requesting position information is undetermined. Consequently, the monitor server 300 does not necessarily specify a target. The monitor server 300 provides the matching server 200 with the image (moving image) provided by the camera 400, and information on the time when the image was acquired (S305). At this point, the monitor server 300 may additionally provide the matching server 200 with information on the position of the camera 400. Doing so may potentially reduce the processing load for matching, similarly to the first embodiment. Likewise, in another embodiment, the monitor server 300 may execute the image analysis and provide the matching server 200 with extracted behavior information.

The matching server 200 executes matching on the basis of the sensor information from the terminal device 100 provided in S303, and the image information provided in S305 (S306). As a result of the matching, the user in the image who corresponds to the terminal device 100 that transmitted the sensor information (the target user) is extracted. The matching server 200 provides the monitor server 300 with information specifying the target user in the image, such as information on the in-image coordinates of the target user, for example, together with the account information corresponding to the target user's terminal device 100 (S307).

The monitor server 300 estimates the target user's actual position from target user's position in the image (S308), and provides the position delivery server 600 with information on the estimated position, together with the target user's account information (S309). The position delivery server 600 issues position information to the user in accordance with the information provided by the monitor server 300 (S310). Note that the estimation of the target user's actual position may not necessarily be executed by the monitor server 300, but may also be executed by the position delivery server 600 or the matching server 200, for example.

(Modification)

Note that in this embodiment, a modification of the system configuration similar to that of the foregoing first embodiment is likewise possible. Whereas in the above example in FIG. 11, a matching server 200, a monitor server 300, a camera 400, and a position delivery server 600 are included in a special-purpose position delivery system, in a modification, a system including a matching server 200 and a camera 400 exists as a general-purpose matching service not limited to position delivery, and this system is utilized by a position delivery server 600. In so doing, it is possible to provide the ad delivery service according to the foregoing first embodiment and the position delivery service according to this embodiment using a shared matching server 200, for example.

(2-2. Functional Configuration of Devices)

Next, a functional configuration of the devices in the system in the above FIG. 11 and the modification thereof will be described. As discussed above, the functional configuration of each device described hereinafter may be realized by information processing apparatus configured as a system. Note that since the functional configuration of every device other than the position delivery server 600 may be designed similarly to the foregoing first embodiment, the description of the foregoing system configuration will be used in lieu of a detailed description.

(Position Delivery Server)

FIG. 12 is a block diagram illustrating a schematic functional configuration of a position delivery server according to the second embodiment of the present disclosure. As illustrated in FIG. 12, the position delivery server 600 includes a registration information acquirer 610, an account storage unit 620, a target information acquirer 630, and a position delivery unit 640. Note that the respective units other than the account storage unit 620 may be realized in software using a CPU, for example.

The registration information acquirer 610 accepts registrations by communication with the terminal device 100 for the purpose of the user of the terminal device 100 using a positioning service. Accepted registration information is recorded to the account storage unit 620, and referenced by the position delivery unit 640 when the user of the terminal device 100 is specified as the target user by matching. The registration information may include information regarding a destination for position delivery (such as an email address, a device ID, or a push notification token), for example.

The target information acquirer 630 acquires, from the monitor server 300 (or the matching server 200), the position (detailed position) of the target user specified as a result of matching, and account information for the target user's terminal device 100.

The position delivery unit 640 delivers position information to the user's terminal device 100 in accordance with the information acquired by the target information acquirer 630. The delivered position information is not limited to information such as coordinates on a map, for example, and may also include information indicating a particular floor in a building, the sections or zones of a building, and nearby landmarks, for example.

(2-3. Additional Uses for Image Processing)

In an embodiment of the present disclosure, it is also possible to track a target user in an image by image tracking once a particular target user has been specified. For example, in the case of the foregoing first embodiment, a target user may be first specified in an image, and then tracked by image tracking, such that when that, user approaches a specific shop, for example, ad information is delivered to the terminal device of the target user that was specified by the first matching. As another example, in the case of the above second embodiment, the relationship between a user in an image and a target device may be first specified, and then tracked by image tracking to continually provide position information to that user.

Also, in an embodiment of the present disclosure, in the case where a once-specified target user leaves a particular camera's image and enters another camera' image, or in the case where the target user returns to the first cameras image, that user may be specified by image matching against an image of the originally specified target user. Combining an embodiment of the present disclosure with image tracking and image matching that applies established image processing technology in this way enables specifying the relationship between a user and a terminal device without executing matching frequently, and the processing load due to matching may be reduced.

### 3. Third Embodiment

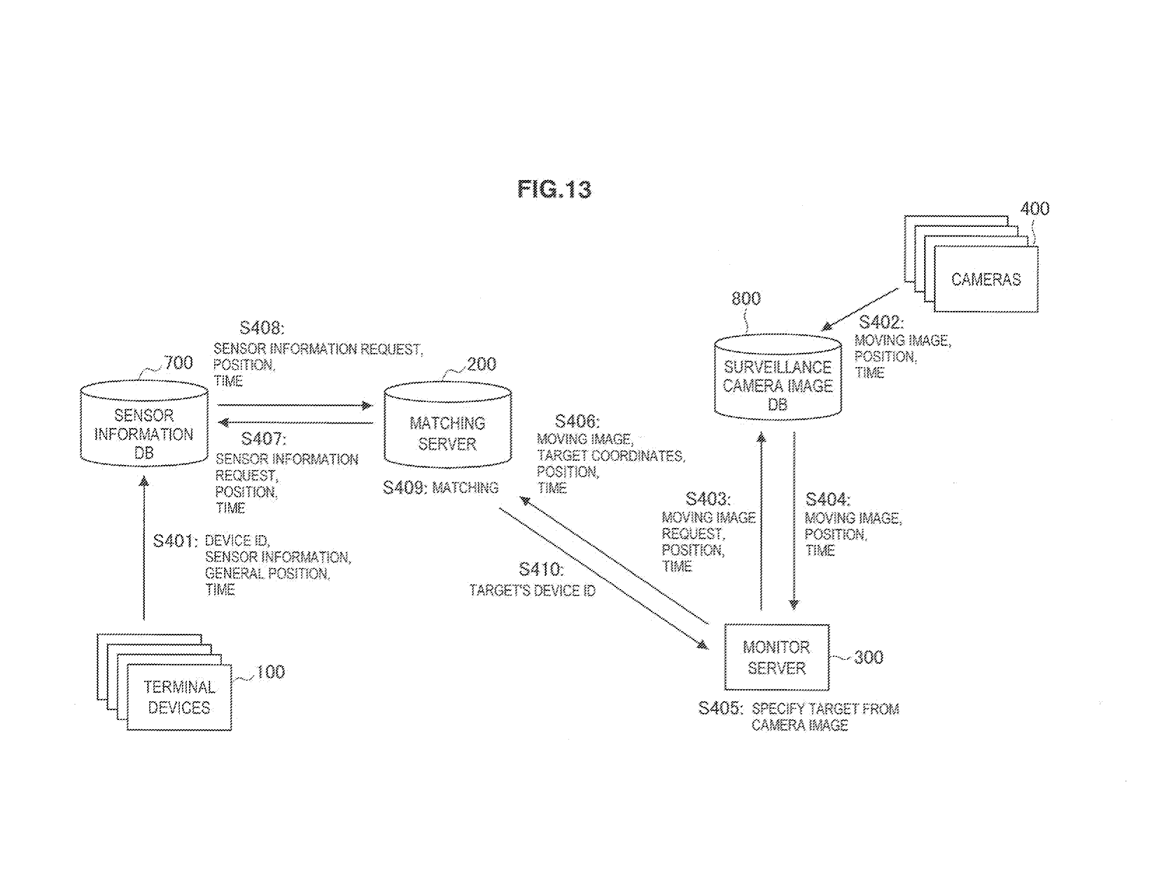

Next, the third embodiment of the present disclosure will be described with reference to FIG. 13. In this embodiment, matching between behavior information detected from an image and behavior information detected from sensor output is executed with respect to accumulated past information. Doing so enables specifying the relationship between a user appearing in an image and a terminal device, even in the case of viewing the camera image afterwards, for example. This embodiment is usable with an ad delivery service or a position delivery service as in the foregoing first and second embodiments, for example, but is also usable in applications such as criminal investigations.

FIG. 13 is a figure illustrating a diagrammatic system configuration according to the third embodiment of the present disclosure. The system includes a terminal device 100, a matching server 200, a monitor server 300, a camera 400, a sensor information database (DB) 700, and a surveillance camera image DB 800. Hereinafter, the operation of each component of the system will be successively described.

The terminal device 100 periodically uploads information, including information such as a device ID, sensor information, general position, and timestamps. The uploaded information is stored in the sensor information DB 700. Note that although the terminal device 100 is registered in the system in order to upload information, the registration procedure is omitted from FIG. 13.

Meanwhile, the camera 400 uploads recorded moving image data, together with information on the positions and times of recording (S402). The uploaded image information is stored in the surveillance camera image DB 800.

In the case of specifying the relationship between a user appearing in an image and a terminal device, the monitor server 300 transmits information on a target position and time to the surveillance camera image DB 800, together with a moving image request (S403). In response to the request, the surveillance camera image DB 800 provides the monitor server 300 with moving image data recorded by the camera 400 at the specified position and time (S404).

At this point, a target user in the camera image is specified at the monitor server 300 by a user operation, for example (S405). The in-image coordinates of the specified target user are transmitted to the matching server 200, together with the moving image data (S406). At this point, information on the position and time at which the camera image was recorded is additionally transmitted in order to reduce the processing load of the matching process, similarly to the foregoing embodiments.

Having received the moving image data from the monitor server 300, the matching server 200 issues a request to the sensor information DB 700 for sensor information (including a device ID) at the position and time corresponding to the moving image data (S407). In response to the request, the sensor information DB 700 provides the matching server 200 with sensor information uploaded from a terminal device 100 at the specified position and time (S408).

Having acquired the sensor information, the matching server 200 executes matching using the moving image data and the sensor information, and specifies the device ID of the terminal device 100 that was being carried by the target user specified in the camera image (S409). The matching server 200 provides the monitor server 300 with information on the specified target user's device ID (S410).

By establishing databases that respectively store sensor information and camera images together with time information, for example, it is possible to specify the relationship between a user appearing in an image and a terminal device that the user is carrying even for past data, similarly to the real-time matching according to the foregoing embodiments.

Note that in the case where matching over past data is possible as described above, for example, a user of a terminal device 100 providing sensor information may find it undesirable to have his or her past position specified in some cases. In such cases, the account information or device ID) attached when uploading sensor information from the terminal device 100 may be a temporary ID that is invalidated once a predetermined period elapses, such as a one-time password (DTP) that is valid only for a predetermined amount of time after the user registers to use a service, for example. In cases where the above is not problematic, the account information (or device ID) attached to the sensor information may be an ID unique to the terminal device 100. The ID may also be information such as an account for the service granted to the user, such that the user is still able to receive the service even in the case of changing the terminal device in use, for example.

### 4. Fourth Embodiment

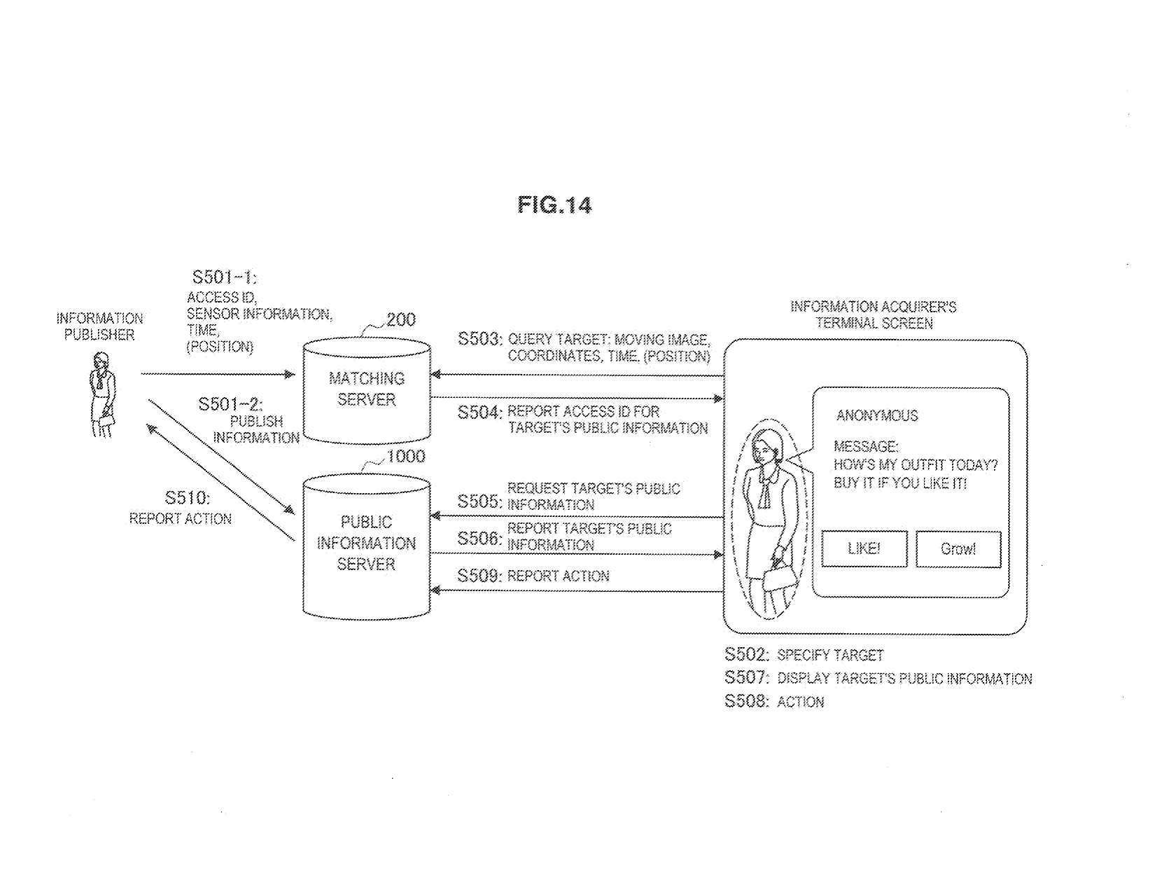

Next, the fourth embodiment of the present disclosure will be described reference to FIG. 14. In this embodiment, a camera on a terminal device carried by a certain user is used similarly to the surveillance camera in the foregoing embodiments.

FIG. 14 is a figure that diagrammatically illustrates the fourth embodiment of the present disclosure. As illustrated in FIG. 14, in this embodiment, the system includes a matching server 200 and a public information server 1000. Hereinafter, processes by the system will be successively described.

First, an access ID and sensor information is transmitted to the matching server 200 from the terminal device of an information publisher (S501-1). At the same time, predetermined information to be made public is transmitted to the public information server 1000 from the terminal device of the information publisher (S501-2). Note that the access ID is an ID for accessing information published by the information publisher, and is later used by an information acquirer. Note that the access ID transmitted at this point is not the ID of the terminal device or the information publisher, but temporary key information for accessing public information. This is because in the example illustrated in FIG. 14, the relationship between the information publisher and the information acquirer is a temporary relationship for the purpose of acquiring public information. Since the access ID has no use after the information is made public, the information publisher is not identified by the information acquirer.

Meanwhile, the information acquirer specifies an information publisher appearing in an image from a camera built into a terminal device as the target user (S502). In so doing, the information acquirer's terminal device transmits a query regarding the target user to the matching server 200 (S503). This query specifies the target user specified by the information acquirer from the image, and may a query requesting access to information that the corresponding user has made public. The query may contain moving image data recorded by the information acquirer's terminal device, the target user's in-image coordinate information, and information on the time and position at which the moving image was recorded.

The matching server 200 extracts the target user's behavior information from the moving image included in the query received in S503, and matches the behavior information with behavior information detected from the sensor information received in S501-1. In the case where the target user's sensor information is specified as a result, the matching server 200 issues the corresponding sensor information as well as the transmitted access ID to the information acquirer's terminal device (S504).

Having been notified of the target user's access ID, the information acquirer's terminal device transmits the access ID to the public information server 1000 and requests the target user's public information (S505). In response, the public information server 1000 issues the target user's (that is, the information publisher's) public information (S506). As a result, public information from the information publisher (in the example illustrated in FIG. 14, an advertisement for his or her clothing) is displayed on the display unit of the information acquirer's terminal device (S507).

The information acquirer is able to perform some kind of action with respect to the public information (S508). In the example illustrated FIG. 14, buttons that indicate approval or appreciation are displayed as the public information, and by pressing these buttons, the information acquirer is able to perform an action indicating his or her approval of the information publisher's clothing. Information on the action is issued to the public information server 1000 (S509), and additionally issued to the terminal device of the information publisher himself or herself (S510).

In this way, a matching process according to an embodiment of the present disclosure is capable of being used not only with an image acquired by a surveillance camera, but also with an image acquired by a camera on a terminal device possessed by a user.

(Modifications)

As a modification of this embodiment, a user may specify a target from among persons contained in a television image, and that target may be identified by matching behavior information. For example, assume that multiple performers on a certain television program are respectively carrying terminal devices, such that while an image of the performers is recorded by a television camera, sensor information from each performer's terminal device is also uploaded. In this case, if a viewer of the television program likes a particular performer among the performers appearing in the image, the viewer may specify that performer as the target user, for example.

In this ease, the matching server matches the behavior of the target user specified in the image to behavior information based on the sensor information from each performer, and identifies the particular performer that the viewer specified as the target user. For example, it is possible to use such matching as an action enabling the viewer to show support for a performer. The performer may also be a competitor in a sports broadcast. For example, a viewer specifying a particular competitor as the target user may result in cheering directed at that competitor, or a small monetary donation.

### 5. Fifth Embodiment

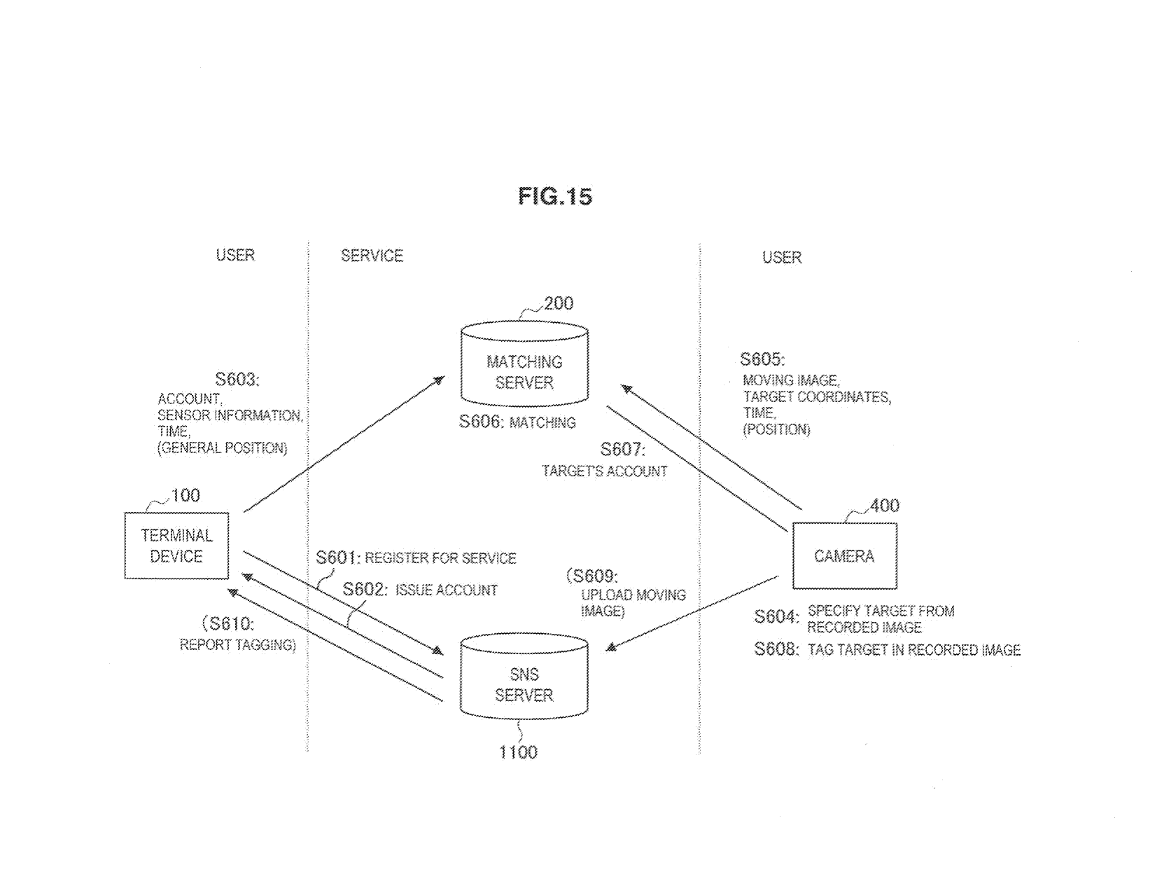

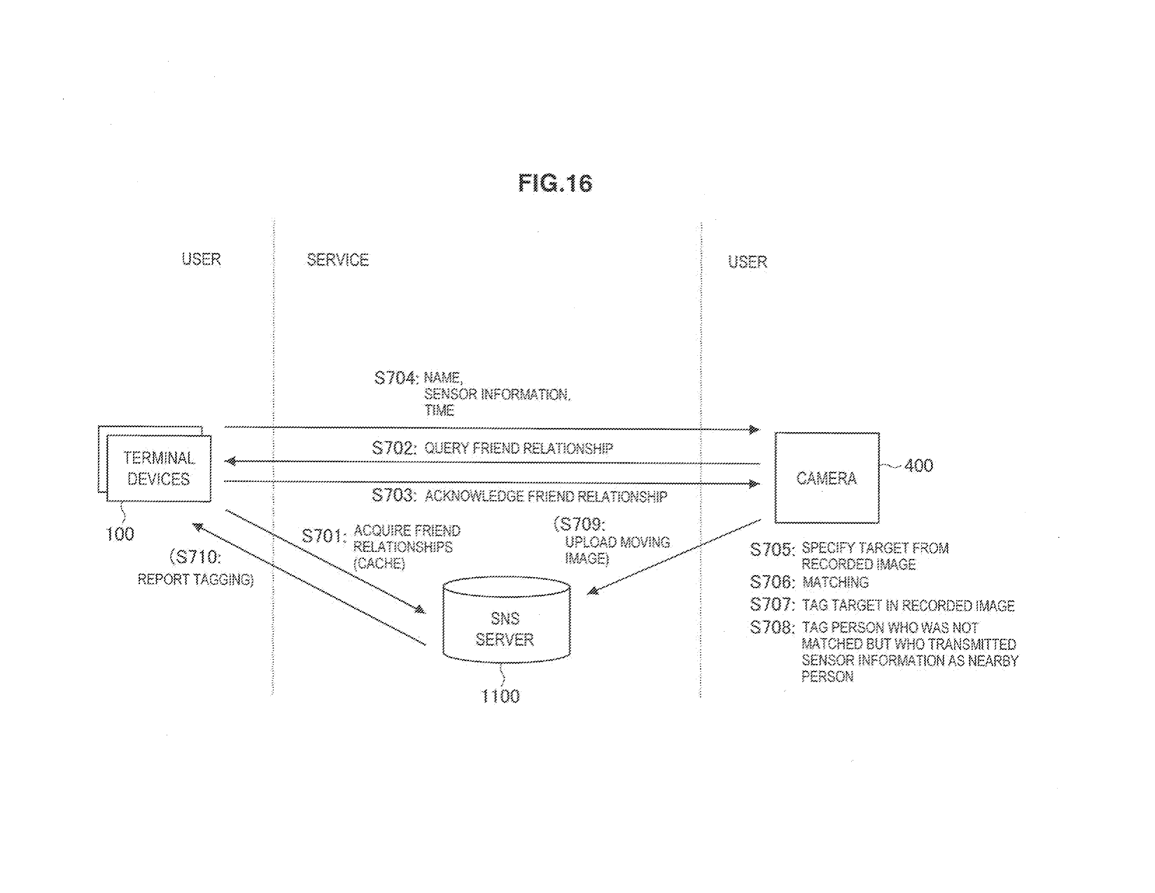

Next, the fifth embodiment of the present disclosure will be described with reference to FIGS. 15 and 16. In this embodiment, a matching process is used to identify another user appearing in an image recorded by a user.

FIG. 15 is a figure illustrating a diagrammatic system configuration according to the fifth embodiment of the present disclosure. The system includes a terminal device 100, a matching server 200, a camera 400, and an SNS server 1100. Hereinafter, the operation of each component of the system will be successively described.

First, service registration (S601) and account issuing (S602) are executed between the terminal device 100 and the SNS server 1100. This is registration for the purpose of the user of the terminal device 100 using a service of being specified in an image by matching. With this registration, the terminal device 100 provides the matching server 200 with account information and sensor information (or behavior information extracted from sensor information), together information (a timestamp) (S603).

Similarly to the foregoing embodiments, the service registration in S601 is not for the purpose of using the account information to identify the user. The information provided by the user to the SNS server 1100 is used as information for associating an SNS account provided by the SNS server 1100 with the user of the terminal device 100. Also, in S603, the sensor information may provide the matching server 200 with general position information in addition to the account information and time information from the terminal device 100.

Meanwhile, a camera 400 possessed by another user records an image depicting the user of the terminal device 100. The user of the camera 400 specifies the person to be identified in the recorded image as the target user (S604). Note that all persons appearing in the recorded image (or persons appearing at a certain size, for example) may also be automatically detected as target users. The camera 400 provides the matching server 200 with moving image data, together with the image coordinates of the specified target user, and information on the time when the image was acquired (S605). At this point, the camera 400 may additionally provide the matching server 200 with information on the position of the camera 400 itself. Note that in another embodiment, the camera 400 may execute the image analysis and provide the matching server 200 with extracted behavior information.

The matching server 200 executes matching on the basis of the sensor information from the terminal device 100 provided in S603, and the image information provided in S605 (S606). As a result of the matching, the account information of the terminal device 100 corresponding to the target user specified in the image is extracted. The matching server 200 provides the camera 400 with the target user's account information (S607).

The camera 400 uses the target user's account information to attach a tag to the target user appearing in the moving image (S608). The tag attached at this point may be a tag for the target user's username on the SNS provided by the SNS server 1100, for example. For this reason, information associating the SNS username with the account information from when the user of the terminal device 100 transmitted sensor information may also be acquired by the camera 400 from the SNS server 1100 in advance. Alternatively, the camera 400 may transmit the target user's account information provided by the matching server 200 to the SNS server 1100, and ask the SNS server 1100 to identify the corresponding user on the SNS.

The camera 400 may additionally upload the tagged moving image to the SNS server 1100 (S609). In the case of uploading a moving image, the SNS server 1100 may also issue a notification to the terminal device 100 indicating that the user of the terminal device 100 was tagged (S610).

According to a configuration like the above, it becomes possible to automatically identify who appears in a moving image recorded with a video camera possessed by a user, and add tags to the moving image, for example. In this case, it may be presumed that each user's terminal device is associated with each user (an account on the SNS, for example) in advance.

At this point, in the case of a person who does not appear in the moving image, but who is near the recording location of the moving image at the time of shooting the moving image, and who exists in a friend relationship on the SNS with the person who recorded the moving image, that person may be tagged in the moving image as a “person nearby at the time of shooting”. In addition, it is also possible to, for example, identify and tag the photographer himself or herself by detecting the behavior of the person holding the camera 400 from the shake in the moving image, and matching this behavior to sensor information from the terminal device 100.

Note that detecting the behavior of the photographer from the shake in the moving image is also applicable to the foregoing embodiments, in the case where a head-mounted terminal device is used and an image indicating the user's field of vision is provided as sensor information, for example.

(Modification)

FIG. 16 is a figure illustrating a modification of a diagrammatic system configuration according to the fifth embodiment of the present disclosure. Whereas a matching server is used to execute matching in the above example in FIG. 15, in this modification the camera 400 executes matching by using machine-to-machine communication with the terminal device 100. Note that various communication protocols such as Bluetooth (registered trademark) and may be used for the machine-to-machine communication. Also, with machine-to-machine communication, the respective devices may not necessarily be directly connected, and may also have a peer-to-peer (P2P) connection via a network such as the Internet, for example.

The terminal device 100 acquires and caches information on friend relationships from the SNS server 1100 in advance (S701). In the case of recording a moving image, the camera 400 transmits a friend relationship query by machine-to-communication to a terminal device 100 positioned nearby (S702). The terminal device 100 references the cached information on friend relationships, and if the user of the camera 400 is a friend, transmits a response acknowledging the friend relationship (S703).

In addition, in the case where the user of the camera 400 is a friend, the terminal device 100 provides the camera 400 with sensor information (S704). The sensor information provided at this point may include information on the name of the user of the terminal device 100 on the SNS, and time information.

Having acquired sensor information from the terminal device 100, the camera 400 specifies a target user from the recorded image (S705), and executes matching using the sensor information and the image of the target user (S706). Note that the target user may be specified by the user of the camera 400, but may also be automatically detected, similarly to the earlier example.

As a result of the matching, the target user corresponding to the sensor information transmitted from a particular terminal device 100 is determined. Thus, the camera 400 uses the sensor information from the terminal device 100 together with the transmitted name information to attach a tag to the target user appearing in the moving image (S707). In addition, in the case of a user whose terminal device 100 transmitted sensor information in S704, but who was not identified by matching, the camera 400 may tag that user as a person who does not appear in the recorded image but is nearby (S708).

The camera 400 may additionally upload the tagged moving image to the SNS server 1100 (S709). In the case of uploading a moving image, the SNS server 1100 may also issue a notification to the terminal device 100 indicating that the user of the terminal device 100 was tagged (S710).

### 6. Hardware Configuration

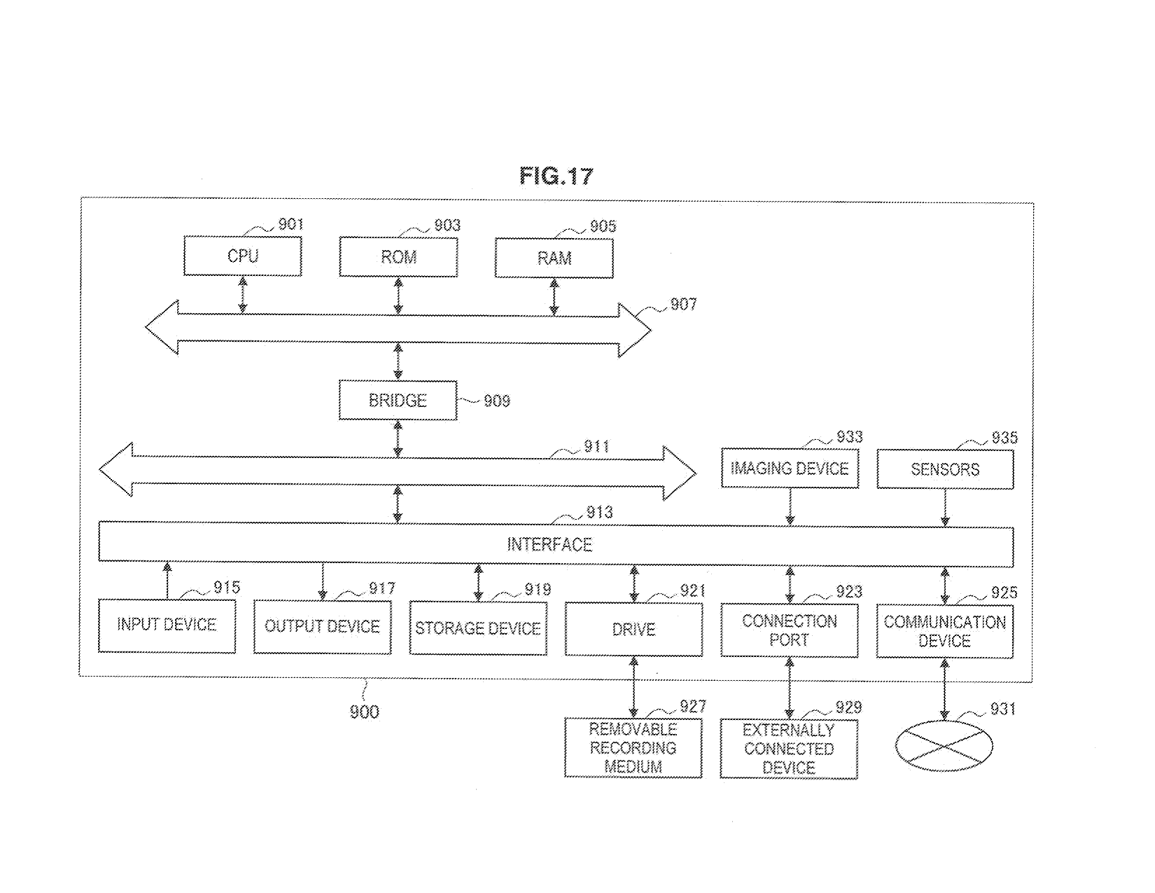

Next, a hardware configuration of an image processing apparatus according to an embodiment of the present disclosure will be described with reference to FIG. 17. FIG. 17 is a block diagram for describing a hardware configuration of an information processing apparatus. The information processing apparatus 900 illustrated in FIG. 17 may realize the terminal device 100, the matching server 200, the monitor server 300, the camera 400, the ad delivery server 500, the position delivery server 600, the sensor information DB 700, the surveillance camera image DB 800, the public information server 1000, and the SNS server 1100 in the foregoing embodiments, for example.

The information processing apparatus 900 includes a central processing unit (CPU) 901, read-only memory (ROM) 903, and random access memory (RAM) 905. The information processing apparatus 900 may also include a host bus 907, a bridge 909, an external bus 911, an interface 913, an input device 915, an output device 917, a storage device 919, a drive 921, a connection port 923, and a communication device 925. In addition, the information processing apparatus 900 may also include an imaging device 933, and sensors 935 as appropriate. The information processing apparatus 900 may also include a processing circuit such as a digital signal processor (DSP) instead of, or together with, the CPU 901.

The CPU 901 functions as a computational processing device and a control device, and controls all or part of the operation in the information processing apparatus 900 by following various programs recorded in the ROM 903, the RAM 905, the storage device 919, or a removable recording medium 927. The ROM 903 stores information such as programs and computational parameters used by the CPU 901. The RAM 905 temporarily stores information such as programs used during execution by the CPU 901, and parameters that change as appropriate during such execution. The CPU 901, the ROM 903, and the RAM 905 are connected to each other by a host bus 907 realized by an internal bus such as a CPU bus. Additionally, the host bus 907 is connected to an external bus 911 such as a Peripheral Component Interconnect/Interface (PCI) bus via a bridge 909.

The input device 915 is a device operated by a user, such as a mouse, a keyboard, a touch panel, or one or more buttons, switches, and levers, for example. The input device 915 may also be a remote control device utilizing infrared or some other electromagnetic wave, and may also be an externally connected device 929 such as a mobile phone associated with the operation of the information processing apparatus 900, for example. The input device 915 includes an input control circuit that generates an input signal on the basis of information input by the user, and outputs the generated input signal to the CPU 901. By operating the input device 915, the user inputs various data and instructs the information processing apparatus 900 to perform processing operations, for example.

The output device 917 is realized by a device capable of visually or aurally reporting acquired information to the user. The output device 917 may be a display device such as a liquid crystal display (LCD), a plasma display panel (PDP), or an organic electro-luminescence (EL) display, an audio output device such as one or more speakers and headphones, or another device such as a printer, for example. The output device 917 may output results obtained from processing by the information processing apparatus 900 in the form of visual information such as text or an image, or in the form of audio such as speech or sound.

The storage device 919 is a device used for data storage, realized as an example of storage in the information processing apparatus 900. The storage device 919 may be a magnetic storage device such as a hard disk drive (HDD), a semiconductor storage device, an optical storage device, or a magneto-optical storage device, for example. The storage device 919 stores information such as programs executed by the CPU 901, various data, and various externally acquired data.

The drive 921 is a reader/writer for a removable recording medium 927 such as a magnetic disk, an optical disc, a magneto-optical disc, or semiconductor memory, and is built into or externally attached to the information processing apparatus 900. The drive 921 retrieves information recorded in an inserted removable recording medium 927, and outputs the retrieved information to the RAM 905. Additionally, the drive 921 writes information to an inserted removable recording medium 927.

The connection port 923 is a port for connecting equipment directly to the information processing apparatus 900. The connection port 923 may be a Universal Serial Bus (USB) port, an IEEE 1394 port, or a Small Computer System Interface (SCSI) port, for example. The connection port 923 may also be an RS-232C port, an optical audio socket, or a High-Definition Multimedia Interface (HDMI) port. By connecting an externally connected device 929 to the connection port 923, various data may be exchanged between the information processing apparatus 900 and the externally connected device 929.

The communication device 925 is a communication interface realized by a communication device that connects to a communication network 931, for example. The communication device 925 may be a wired or wireless local area network (LAN), or a Bluetooth (registered trademark) or Wireless USB (WUSB) communication card, for example. The communication device 925 may also be an optical communication router, an asymmetric digital subscriber line (ADSL) router, or a modem for any of various types of communication. The communication device 925 transmits and receives signals or other information to and from the Internet or another communication device using a predetermined protocol such as TCP/IP, for example. Also, the communication network 931 connected to the communication device 925 is a network connected in a wired or wireless manner, and may be the Internet, a home LAN, infrared communication, radio-wave communication, or satellite communication, for example.

The imaging device 933 is a device that generates an image by imaging a real space using an image sensor such as a charge-coupled device (CCD) or complementary metal-oxide-semiconductor (CMOS) sensor, as well as various members such as one or more lenses for controlling the formation of a subject image on the image sensor, for example. The imaging device 933 may be a device that takes still images or a device that takes moving images.

The sensors 935 are various sensors such as an acceleration sensor, a gyro sensor, a geomagnetic sensor, a barometric pressure sensor, an optical sensor, and a sound sensor, for example. The sensors 935 acquire information regarding the state of the information processing apparatus 900 itself, such as the orientation of the case of the information processing apparatus 900, as well as information regarding the environment surrounding the information processing apparatus 900, such as the brightness or noise surrounding the information processing apparatus 900, for example. The sensors 935 may also include a Global Positioning System (GPS) sensor that receives GPS signals and measures the latitude, longitude, and altitude of the apparatus.

The foregoing thus illustrates an exemplary hardware configuration of the information processing apparatus 900. Each of the above components may be realized using general-purpose members, but may also be realized in hardware specialized in the function of each component. Such a configuration may also be modified as appropriate according to the technological level at the time of the implementation.

### 7. Supplemental Remarks

(Conclusion of Service Examples)

The following summarizes the examples of services which may be provided using an embodiment of the present disclosure.

For example, an embodiment of the present disclosure is applicable to a coupon and ad distribution service. In this case, a user approaching a shop is identified from an image, and coupon information according to that user's attributes is transmitted, for example. Thus, an advertising effect similar to handing out tissues (a distributor handing out packages of tissues with an ad insert according to the attributes of passersby), such as presenting makeup ads to female customers, for example, can be expected.

As another example, an embodiment of the present disclosure is also applicable as a positioning solution. As discussed earlier, using GPS indoors is difficult indoors, whereas positioning using a Wi-Fi or other access point is insufficiently precise. According to an embodiment of the present disclosure, it is possible to tell a user “you are here” with high precision, even indoors.

As another example, an embodiment of the present disclosure is also usable for the purpose of determining that a customer has entered a shop. Heretofore, a user would execute some kind of check-in operation (such as acquiring position information corresponding to a shop) to notify the system of his or her arrival. However, according to an embodiment of the present disclosure, it is possible to identify the terminal device of a user entering a shop, thus making it possible to report a customer's arrival even without a check-in operation. Also, if a camera is installed in the shop at the entrance or the cash register counter, and if users appearing in respective images are identified, it is possible to distinguish between users who actually purchased a product at the shop versus users who only looked around. Furthermore, if the terminal device ID is unique information used on an ongoing basis, it is also possible to record frequency of visits together with user attributes. Since the target of identification is the terminal device, identification is unaffected even if features such as the user's clothing and hairstyle change, for example.

As another example, an embodiment of the present disclosure is also usable for criminal investigation. For example, it is possible to accumulate images from a security camera, and when some kind of incident occurs, infer the identity of the criminal by identifying the terminal device from which was acquired behavior information matching the behavior information of the criminal appearing on camera.

As another example, an embodiment of the present disclosure is also usable for specialized guidance devices used at facilities such as art galleries and museums. For example, by mounting sensors onto the specialized device and matching behavior information detected from the sensor information from each specialized device to the behavior information of a user appearing on a camera in the facility, it is possible to provide detailed information on the user's position inside the facility, and transmit guide information on exhibits according to the user's position.

(Other Remarks)

Although the description of the foregoing embodiments introduces the example of a user (person) carrying a terminal device that acquires sensor information, an embodiment of the present disclosure is not limited to such an example. For example, a terminal device may also be attached to animals such as livestock. In this case, when an individual separated from the herd is recognized from an image, that individual is specified as the target. If the terminal device attached to the individual is identified by matching, it is possible to issue, via that terminal device, instructions or other stimuli prompting the individual to return to the herd. Also, since an individual can be identified while observing an image, it is also possible to execute actions such as individual selection from a remote location.

A terminal device that acquires sensor information may also be attached to packages. In this case, packages may be selected from a remote location, similarly to the case of livestock, for example. In addition, such an embodiment is also usable in cases such as visually checking, via an image, packages being transported to locations where workers are unable to enter, and setting flag information for the terminal device as appropriate.

Embodiments of the present disclosure encompass an information processing apparatus (a terminal device or a server) and system as described in the foregoing, an information processing method executed by an information processing apparatus or system, a program for causing an information processing apparatus to function, and a recording medium storing such a program, for example.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus including:

a first acquirer that acquires first behavior information, the first behavior information being detected by analysis of an image related to an object and indicating behavior of the object;

a second acquirer that acquires second behavior information, the second behavior information being detected from an output of a sensor in a terminal device carried by or attached to the object and indicating the behavior of the object; and

a matching unit that specifies a relationship between the object and the terminal device by matching the first behavior information to the second behavior information.

(2) The information processing apparatus according to (1), wherein

the matching unit matches, on a time axis, feature points in the behavior of the object, the feature points being indicated by the first behavior information and the second behavior information.

(3) The information processing apparatus according to (2), wherein

the second acquirer acquires the second behavior information detected from an output of an acceleration sensor in the terminal device.

(4) The information processing apparatus according to (2) or (3), wherein

the object is a person, and

the matching unit matches, on a time axis, feature points in walking behavior of the person, the feature points being indicated by the first behavior information and the second behavior information.

(5) The information processing apparatus according to any one of (1) to (4), wherein

the first acquirer acquires the first behavior information for a target specified from a plurality of the objects, and

the matching unit specifies the terminal device carried by or attached to the target by matching the first behavior information to the second behavior information,

(6) The information processing apparatus according to (5), wherein

the target is specified as an object having a predetermined attribute, and

the matching unit outputs information on the specified terminal device as information for delivering information to the target.

(7) The information processing apparatus according to (5), wherein

the target is specified as an unidentified object, and

the matching unit outputs information on the specified terminal device as information that identifies the target.

(8) The information processing apparatus according to (7), wherein

the information that identifies the target is temporary key information used for the target to access information that has been made public.

(9) The information processing apparatus according to any one of (1) to (4), wherein

the second acquirer acquires the second behavior information for a target terminal device specified from a plurality of the terminal devices, and

the matching unit specifies the object carrying or attached to the target terminal device by matching the first behavior information to the second behavior information.

(10) The information processing apparatus according to (9), wherein

the target terminal device is a terminal device requesting position information, and

the matching unit outputs information on the specified object in a manner that the position of the object specified on the basis of the image is reported to the target terminal device.

(11) The information processing apparatus according to any one of (1) to (10), wherein

the object is a person,

the second acquirer acquires the second behavior information associated with ID information that identifies the person, and

the matching unit specifies the person using the ID information.

(12) The information processing apparatus according to (11), wherein

the ID information is invalidated once a predetermined period of time elapses.

(13) The information processing apparatus according to (11) or (12), wherein

the matching unit outputs the ID information associated with the object in a manner that tag information indicating the object is attached to the image.

(14) The information processing apparatus according to any one of (1) to (13), wherein

the first acquirer acquires the first behavior information detected by analysis of a plurality of the images taken from different positions,

the second acquirer acquires the second behavior information associated with information indicating a general position of the terminal device, and

the matching unit uses the information indicating the general position to select the first behavior information used for matching.

(15) The information processing apparatus according to any one of (1) to (14), wherein

in a case where the object and the terminal device whose relationship has been specified by matching appear in a later image, the matching unit omits matching for the later image by identifying the object using a feature of the object in the image.

(16) The information processing apparatus according to airy one of (1) to (15), wherein

the second acquirer acquires the second behavior information including information on an orientation of the object, the information being detected from an output of a geomagnetic sensor in the terminal device.

(17) The information processing apparatus according to any one of (1) to (16), wherein

the object is a person or an animal, and

the second acquirer acquires the second behavior information including information on an image of the object's field of vision, the information being detected from an output of an imaging unit in the terminal device.

(18) The information processing apparatus according to any one of (1) to (17), wherein

the second acquirer acquires the second behavior information including information on altitude of the object, the information being detected from an output of a barometric pressure sensor in the terminal device.

(19) An information processing method including:

acquiring first behavior information, the first behavior information being detected by analysis of an image related to an object and indicating behavior of the object;

acquiring second behavior information, the second behavior information being detected from an output of a sensor in a terminal device carried by or attached to the object and indicating the behavior of the object; and

specifying a relationship between the object and the terminal device by matching the first behavior information to the second behavior information.

(20) A program for causing a computer to realize;

a function of acquiring first behavior information, the first behavior information being detected by analysis of an image related to an object and indicating behavior of the object;

a function of acquiring second behavior information, the second behavior information being detected from an output of a sensor in a terminal device carried by or attached to the object and indicating the behavior of the object; and

a function of specifying a relationship between the object and the terminal device by matching the first behavior information to the second behavior information.

The present disclosure contains subject matter related to that disclosed in Japanese Priority Patent Application JP 2012-125940 filed in the Japan Patent Office on Jun. 1, 2012, the entire content of which is hereby incorporated by reference.

What is claimed is:

1. An information processing apparatus comprising:
a first acquirer that acquires first behavior information, the first behavior information being detected by analysis of an image related to an object and indicating behavior of the object;
a second acquirer that acquires second behavior information, the second behavior information being detected from an output of a sensor in a terminal device carried by or attached to the object and indicating the behavior of the object; and
a matching unit that specifies a relationship between the object and the terminal device by matching the first behavior information to the second behavior information.

2. The information processing apparatus according to claim 1, wherein
the matching unit matches, on a time axis, feature points in the behavior of the object, the feature points being indicated by the first behavior information and the second behavior information.

3. The information processing apparatus according to claim 2, wherein
the second acquirer acquires the second behavior information detected from an output of an acceleration sensor in the terminal device.

4. The information processing apparatus according to claim 2, wherein
the object is a person, and
the matching unit matches, on a time axis, feature points in walking behavior of the person, the feature points being indicated by the first behavior information and the second behavior information.

5. The information processing apparatus according to claim 1, wherein
the first acquirer acquires the first behavior information for a target specified from a plurality of the objects, and
the matching unit specifies the terminal device carried by or attached to the target by matching the first behavior information to the second behavior information.

6. The information processing apparatus according to claim 5, wherein
the target is specified as an object having a predetermined attribute, and
the matching unit outputs information on the specified terminal device as information for delivering information to the target.

7. The information processing apparatus according to claim 5, wherein
the target is specified as an unidentified object, and
the matching unit outputs information on the specified terminal device as information that identifies the target.

8. The information processing apparatus according to claim 7, wherein
the information that identifies the target is temporary key information used for the target to access information that has been made public.

9. The information processing apparatus according to claim 1, wherein
the second acquirer acquires the second behavior information for a target terminal device specified from a plurality of the terminal devices, and
the matching unit specifies the object carrying or attached to the target terminal device by matching the first behavior information to the second behavior information.

10. The information processing apparatus according to claim 9, wherein
the target terminal device is a terminal device requesting position information, and
the matching unit outputs information on the specified object in a manner that the position of the object specified on the basis of the image is reported to the target terminal device.

11. The information processing apparatus according to claim 1, wherein
the object is a person,
the second acquirer acquires the second behavior information associated with ID information that identifies the person, and
the matching unit specifies the person using the ID information.

12. The information processing apparatus according to claim 1, wherein
the ID information is invalidated once a predetermined period of time elapses.

13. The information processing apparatus according to claim 11, wherein
the matching unit outputs the ID information associated with the object in a manner that tag information indicating the object is attached to the image.

14. The information processing apparatus according to claim 1, wherein
the first acquirer acquires the first behavior information detected by analysis of a plurality of the images taken from different positions,
the second acquirer acquires the second behavior information associated with information indicating a general position of the terminal device, and
the matching unit uses the information indicating the general position to select the first behavior information used for matching.

15. The information processing apparatus according to claim 1, wherein
in a case where the object and the terminal device whose relationship has been specified by matching appear in a later image, the matching unit omits matching for the later image by identifying the object using a feature of the object in the image.

16. The information processing apparatus according to claim 1, wherein
the second acquirer acquires the second behavior information including information on an orientation of the object, the information being detected from an output of a geomagnetic sensor in the terminal device.

17. The information processing apparatus according to claim 1, wherein
the object is a person or an animal, and
the second acquirer acquires the second behavior information including information on an image of the object's field of vision, the information being detected from an output of an imaging unit in the terminal device.

18. The information processing apparatus according to claim 1, wherein
the second acquirer acquires the second behavior information including information on altitude of the object, the information being detected from an output of a barometric pressure sensor in the terminal device.

19. An information processing method comprising:
acquiring first behavior information, the first behavior information being detected by analysis of an image related to an object and indicating behavior of the object;
acquiring second behavior information, the second behavior information being detected from an output of a sensor in a terminal device carried by or attached to the object and indicating the behavior of the object; and
specifying a relationship between the object and the terminal device by matching the first behavior information to the second behavior information.

20. A program for causing a computer to realize:
a function of acquiring first behavior information, the first behavior information being detected by analysis of an image related to an object and indicating behavior of the object;
a function of acquiring second behavior information, the second behavior information being detected from an output of a sensor in a terminal device carried by or attached to the object and indicating the behavior of the object; and
a function of specifying a relationship between the object and the terminal device by matching the first behavior information to the second behavior information.
